(19) United States
(12) Patent Application Publication
(10) Pub. No.: US 2026/0104633 A1
(43) Pub. Date: Apr. 16, 2026

(54) CAMERA MODULE

(71) Applicant: LG INNOTEK CO., LTD., Seoul (KR)

(72) Inventor: Seung Hyeon JEONG, Seoul (KR)

(21) Appl. No.: 19/114,579

(22) PCT Filed: Sep. 22, 2023
(86) PCT No.: PCT/KR2023/014558

§ 371 Date: Mar. 24, 2025

(30) Foreign Application Priority Data
Sep. 23, 2022 (KR) 10-2022-0120681
Sep. 23, 2022 (KR) 10-2022-0120682

(51) Int. Cl. G03B 30/00; G03B 17/02

(52) U.S. Cl. CPC G03B 30/00; G03B 17/02

(57) ABSTRACT

Disclosed in an embodiment is a camera module including: a lens assembly; a first body on which the lens assembly is disposed; a second body connected to the first body; an image sensor disposed within the second body; and a substrate portion on which the image sensor is disposed, wherein the second body includes a protrusion protruding toward the image sensor, the protrusion being connected to the image sensor and overlapping the image sensor in the optical axis direction.

### TECHNICAL FIELD

The present invention relates to a camera module.

### BACKGROUND ART

Recently, many cameras including not only rear cameras but also cameras for advanced driver assistance systems (ADAS) such as surround view monitoring (SVM) cameras have been mounted on vehicles, and in the future, it will be expected that many cameras with various functions are installed on vehicles.

However, vehicle cameras currently developed and marketed have a greater size and more expensive than cameras used in mobile electronic devices, and this is because the demand for reducing the size is not greatly required and the reliability of operation is more important when compared to the cameras used in the mobile electronic devices, and thus research and development on reliability aspects has been actively conducted.

However, recently, the number of cameras used in a vehicle has been increasing, and cameras with higher performance and reliability than the conventional cameras have been required.

### DETAILED DESCRIPTION OF INVENTION

### Technical Problem

Embodiments are directed to providing a camera module in which, when the camera module is used in a vehicle, an arrangement space for circuit elements is easily secured and of which a heat dissipation function is improved using a protrusion of a body in order for reliability improvement.

In addition, the embodiments are directed to providing a camera module which is easy to be compact in one direction using a bent structure.

In addition, the embodiments are directed to providing a camera module which is easily assembled and of which a coupling force and durability are improved.

Objects to be solved by the embodiments are not limited thereto and may include objects and effects which may be achieved from technical solutions of the objects or embodiments which will be described below.

### Technical Solution

A camera module according to an embodiment includes a lens assembly, a first body on which the lens assembly is disposed, a second body connected to the first body, an image sensor disposed inside the second body, and a substrate part on which the image sensor is disposed, wherein the second body includes a protrusion protruding toward the image sensor, and the protrusion is connected to the image sensor and overlaps the image sensor in an optical axis direction.

The protrusion may pass through the substrate part.

The substrate part

may include a first substrate on which the image sensor is disposed and a second substrate spaced apart from the first substrate.

The second substrate may include a hole through which the protrusion passes.

The substrate part may include a connecting part which connects the first substrate to the second substrate.

The first substrate and the second substrate may be disposed apart from each other in the optical axis direction and overlap in the optical axis direction.

The protrusion may pass through the second substrate.

The camera module may include a pad disposed between the protrusion and the first substrate.

The pad may be in contact with the first substrate and the protrusion.

The substrate part may include a protection member disposed on a side portion of the first substrate.

The protection member

may include a first sub-member, a second sub-member spaced apart from the first sub-member, and a third sub-member which connects the first sub-member to the second sub-member.

The third sub-member may overlap the second substrate in an optical axis direction.

The first sub-member and the second sub-member may be disposed on an outer side of the first substrate.

The second substrate may include a substrate protrusion extending outward.

The first sub-member may include a hole member through which the substrate protrusion passes.

The hole member may be disposed at a predetermined separation distance from the substrate protrusion.

The camera module may include a first connecting terminal and a second connecting terminal which are connected to the substrate part.

A camera module according to an embodiment includes a lens assembly, a first body on which the lens assembly is disposed, a second body connected to the first body, an image sensor disposed inside the second body, and a substrate part on which the image sensor is disposed, wherein the second body includes a protrusion protruding toward the image sensor, the substrate part includes a first substrate on which the image sensor is disposed, a second substrate disposed apart from the first substrate, and a third substrate disposed apart from the second substrate, and the protrusion passes through at least one of the second substrate and the third substrate.

The protrusion may pass through at least a part of the first substrate.

The protrusion may be connected to the image sensor and overlap the image sensor in the optical axis direction.

The protrusion may pass through the second substrate and the third substrate.

The second substrate may be disposed between the first substrate and the third substrate.

The second substrate and the third substrate may include a hole through which the protrusion passes.

The substrate part may include a first connecting part which connects the first substrate to the second substrate and a second connecting part which connects the second substrate to the third substrate.

The substrate part may include a first connecting part which connects the first substrate to the second substrate and a second connecting part which connects the second substrate to the third substrate.

The first connecting part and the second connecting part may be disposed to face or not intersect each other on the second substrate.

The first substrate and the second substrate may be disposed spaced apart from each other in the optical axis direction, and the second substrate and the third substrate may be disposed apart from each other in the optical axis direction.

The camera module may include a pad disposed between the protrusion and the first substrate.

The pad may be in contact with the first substrate and the protrusion.

The substrate part may include a first protection member disposed on a side portion of the first substrate.

The substrate part may include a second protection member disposed on a side portion of the second substrate.

The second substrate may include a first substrate protrusion passing through the first protection member, and the third substrate may include a second substrate protrusion passing through the second protection member.

The first protection member may be disposed inside the second protection member.

The first protection member may extend between the third substrate and the second substrate.

### Advantageous Effects

According to an embodiment, a camera module, in which, when the camera module is used in a vehicle, an arrangement space for circuit elements is easily secured and of which a heat dissipation function is improved using a protrusion of a body in order for reliability improvement, can be implemented. That is, the camera module for effectively controlling internal heat of a vehicle camera can be implemented by adding a simple structure.

In addition, a camera module, which can be easy to be compact in one direction using a bent structure, can be implemented.

In addition, a camera module, which is easily assembled and of which a coupling force and durability are improved, can be implemented.

Various useful advantages and effects of the present invention are not limited to the above-described contents and can be more easily understood through detailed description of specific embodiments of the present invention.

### DESCRIPTION OF DRAWINGS

FIG. 1 is one perspective view illustrating a camera module according to a first embodiment.

FIG. 2 is another perspective view illustrating the camera module according to the first embodiment.

FIG. 3 is an exploded perspective view illustrating the camera module according to the first embodiment.

FIG. 4 is one perspective view illustrating a substrate part in the camera module according to the first embodiment.

FIG. 5 is another perspective view illustrating the substrate part in the camera module according to the first embodiment.

FIG. 6 is one side view illustrating the substrate part in the camera module according to the first embodiment.

FIG. 7 is another side view illustrating the substrate part in the camera module according to the first embodiment.

FIG. 8 is a cross-sectional view along line AA′ in FIG. 5.

FIG. 9 is a perspective view of FIG. 8.

FIG. 10 is a cross-sectional view along line BB′ in FIG. 5.

FIG. 11 is a perspective view of FIG. 10.

FIG. 12 is a plan view illustrating the substrate part, which is unfolded, in the camera module according to the first embodiment.

FIG. 13 is a bottom view illustrating the substrate part, which is unfolded, in the camera module according to the first embodiment.

FIG. 14 is a cross-sectional view illustrating the camera module according to the first embodiment.

FIG. 15 is a perspective view of FIG. 14.

FIG. 16 shows views for describing effects of the camera module according to the first embodiment.

FIG. 17 is one perspective view illustrating a camera module according to a second embodiment.

FIG. 18 is another perspective view illustrating the camera module according to the second embodiment.

FIG. 19 is an exploded perspective view illustrating the camera module according to the second embodiment.

FIG. 20 is a perspective view illustrating a substrate part in the camera module according to the second embodiment.

FIG. 21 is a plan view illustrating the substrate part in the camera module according to the second embodiment.

FIG. 22 is a bottom view illustrating the substrate part in the camera module according to the second embodiment.

FIG. 23 is a perspective view illustrating the substrate part and a first body in the camera module according to the second embodiment.

FIG. 24 is a cross-sectional view illustrating the camera module according to the second embodiment.

FIG. 25 is one perspective view illustrating a substrate part in a camera module according to a third embodiment.

FIG. 26 is another perspective view illustrating the substrate part in the camera module according to the third embodiment.

FIG. 27 is one side view illustrating the substrate part in the camera module according to the third embodiment.

FIG. 28 is another side view illustrating the substrate part in the camera module according to the third embodiment.

FIG. 29 is a cross-sectional view along line CC′ in FIG. 26.

FIG. 30 is a perspective view of FIG. 29.

FIG. 31 is a cross-sectional view along line DD′ in FIG. 26.

FIG. 32 is a perspective view of FIG. 31.

FIG. 33 is a plan view illustrating the substrate part, which is unfolded, in the camera module according to the third embodiment.

FIG. 34 is a bottom view illustrating the substrate part, which is unfolded, in the camera module according to the third embodiment.

FIG. 35 is a plan view illustrating the substrate part, of which a portion is folded, in the camera module according to the third embodiment.

FIG. 36 is a bottom view illustrating the substrate part, of which the portion is folded, in the camera module according to the third embodiment.

FIG. 37 is a plan view illustrating the substrate part, which is folded completely, in the camera module according to the third embodiment.

FIG. 38 is a cross-sectional view illustrating the camera module according to the third embodiment.

FIG. 39 is a perspective view of FIG. 38.

FIG. 39 is a cross-sectional view illustrating a camera module according to a fourth embodiment.

FIG. 40 is a cross-sectional view illustrating a camera module according to a fifth embodiment.

### MODES OF THE INVENTION

Hereinafter, exemplary embodiments of the present invention will be described with reference to the accompanying drawings.

However, the technical spirit of the present invention is not limited to some embodiments which will be described and may be implemented in a variety of different forms, and one or more components of the embodiments may be selectively combined, substituted, and used within the range of the technical spirit of the present invention.

In addition, unless clearly and specifically defined otherwise by the context, all terms (including technical and scientific terms) used herein can be interpreted as having meanings customarily understood by those skilled in the art, and the meanings of generally used terms, such as those defined in commonly used dictionaries, will be interpreted in consideration of contextual meanings of the related art.

In addition, the terms used in the embodiments of the present invention are considered in a descriptive sense only and not to limit the present invention.

In the present specification, unless specifically indicated otherwise by the context, singular forms include plural forms, and in a case in which “at least one (or one or more) among A, B, and C” is described, this may include at least one combination among all possible combinations of A, B, and C.

In addition, in descriptions of components of the present invention, terms such as “first,” “second,” “A,” “B,” “(a),” and “(b)” may be used.

The terms are only to distinguish one component from another component, and the essence, order, and the like of the components are not limited by the terms.

In addition, it should be understood that, when a first component is referred to as being “connected,” “coupled,” or “linked” to a second component, such a description may include both a case in which the first component is directly connected, coupled, or linked to the second component, and a case in which the first component is connected or coupled to the second component with a third component disposed therebetween.

In addition, when a first component is described as being formed or disposed “on (above)” or “under (below)” a second component, such a description includes both a case in which the two components are formed or disposed in direct contact with each other and a case in which one or more other components are interposed between the two components. In addition, when the first component is described as being formed “on (above) or under (below)” the second component, such a description may include a case in which the first component is formed at an upper side or a lower side with respect to the second component.

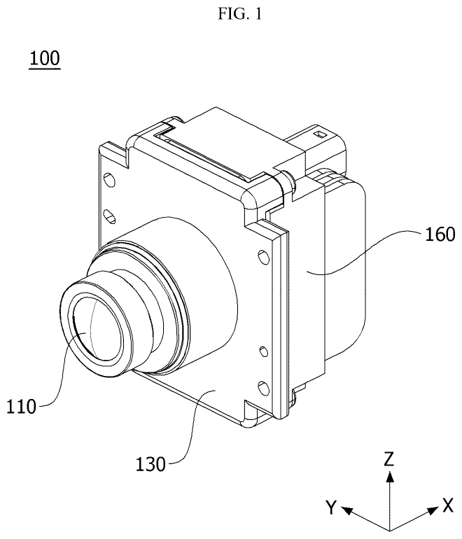

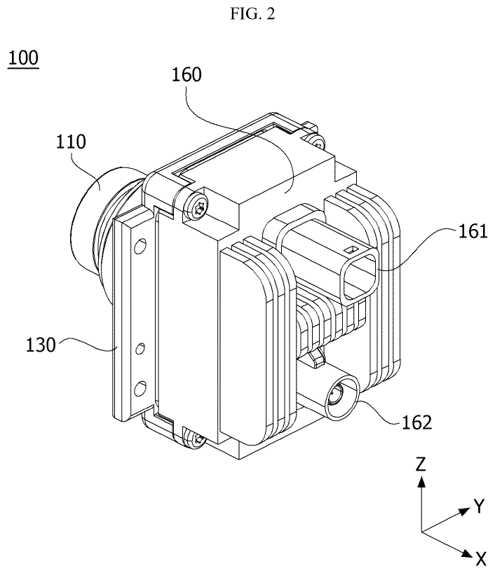

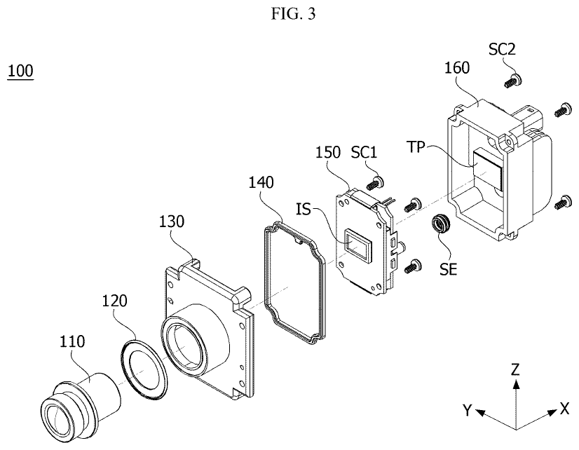

FIG. 1 is one perspective view illustrating a camera module according to a first embodiment, FIG. 2 is another perspective view illustrating the camera module according to the first embodiment, and FIG. 3 is an exploded perspective view illustrating the camera module according to the first embodiment.

Referring to FIGS. 1 to 3, a camera module 100 according to the first embodiment may include a lens assembly 110, a bonding member 120, a first body 130, a gasket 140, a substrate part 150, a second body 160, a pad TP, and coupling members SC1 and SC2.

Specifically, the lens assembly 110 may be located at one end of the camera module 100. For example, the lens assembly 110 may be located at a front end of the camera module 100. The lens assembly 110 may include a plurality of lenses. For example, light incident on the camera module 100 in a vehicle may pass through the plurality of lenses. Various members (for example, a cover glass, a cover, a spacer, etc.) may be further present in the lens assembly 110 such that at least one lens is mounted on the lens assembly 110.

The first body 130 may be connected to the lens assembly 110. The first body 130 may be coupled to the lens assembly 110. In other words, the lens assembly 110 may be disposed on the first body 130. The bonding member 120 may be disposed between the first body 130 and the lens assembly 110. The bonding member 120 may be formed of a resin such as epoxy to allow the lens assembly to variously perform active alignment. For example, the lens assembly 110 may move in the first body 130, and then the bonding member 120 may be cured by heat or the like for the active alignment with an image sensor IS in the camera module 100. Accordingly, the first body 130 and the lens assembly 110 may be coupled to each other through the bonding member 120.

The first body 130 may include a hole, and a portion of the lens assembly 110 may be located in the hole. In addition, the first body 130 may be connected to the second body 160 to form an empty space therein. The gasket 140, the substrate part 150, the image sensor IS, and the like may be disposed in the empty space.

The first body 130 may have any of various strictures to be coupled with the substrate part 150 or the second body 160. For example, the first body 130 may be screw-coupled to the substrate part 150 or the second body 160. To this end, the first body 130 may include a groove or hole for screw-coupling.

The gasket 140 may be located under the first body 130. In addition, the gasket 140 may be located between the first body 130 and the second body 160. The gasket 140 may suppress foreign matter from being introduced into the first body 130 and the second body 160.

The substrate part 150 may be located between the first body 130 and the second body 160 which are spaced apart from each other. Alternatively, the substrate part 150 may be located in the internal space formed by the first body 130 and the second body 160.

The substrate part 150 may include circuit elements and a pattern for connecting the elements. In addition, the image sensor IS may be mounted on the substrate part 150. That is, the image sensor IS may be disposed on the substrate part 150. Accordingly, the image sensor IS may also be located on the second body 160 or the first body 130. The image sensor IS may be a separate component disposed on the substrate part 150, but hereinafter, it will be described that the image sensor IS is included in the substrate part 150. In addition, the image sensor IS may include various devices which convert an optical signal into an electrical signal.

The second body 160 may also be connected to the first body 130. For example, the second body 160 may be sequentially disposed with respect to the first body 130 in an optical axis direction. The second body 160 may include connectors 161 and 162. For example, the second body 160 may include a first connector 161 and a second connector 162 which protrude outward. The first connector 161 and the second connector 162 may surround first and second connecting terminals which will be described below when the substrate part 150 is described. That is, the connectors may protect the connecting terminals of the substrate part 150. Accordingly, the camera module according to the embodiment may be connected to an external device (for example, a vehicle, or a controller in a vehicle). Accordingly, the camera module may receive power or data. In addition, the camera module may perform a predetermined operation using a driver integrated circuit (IC), a processor, or a controller disposed on the substrate part 150 in the camera module.

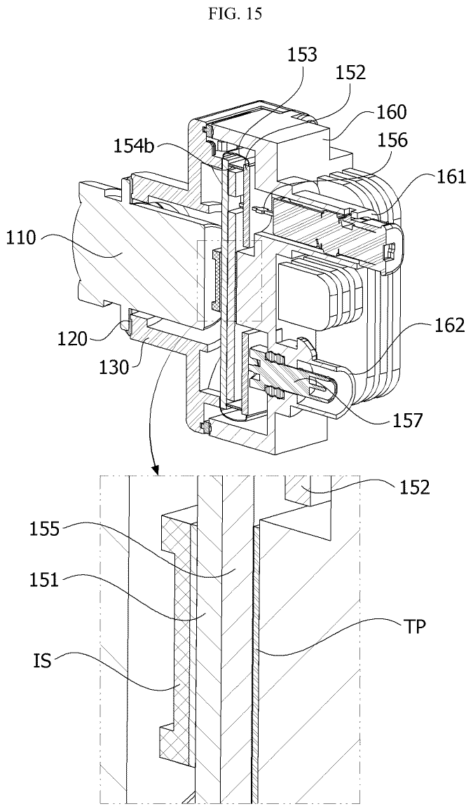

In addition, the second body 160 may include an inner groove 160g (see FIG. 14). The substrate part 150 may be located in the inner groove. In addition, the second body 160 may include a protrusion 160p (see FIG. 14) protruding from the inner groove toward the image sensor IS or the substrate part 150. The protrusion may be connected to the image sensor IS and overlap the image sensor IS in the optical axis direction. The protrusion may be disposed adjacent to the image sensor IS. According to the above-described configuration, heat generated from the image sensor IS may be easily dispersed through the second body. In addition, the heat generated from the image sensor IS may be transferred to the second body and dissipated to the outside. Accordingly, the durability or reliability of the camera module 100 according to the embodiment can be improved.

In addition, the optical axis direction may correspond to a first direction (X-axis direction). The optical axis direction may correspond to a direction in which light is incident on the image sensor. That is, the optical axis direction may be a direction toward the image sensor in the lens assembly. In addition, the optical axis direction may also correspond to a separation direction between the first body and the second body. In addition, a second direction corresponds to a Y-axis direction illustrated in the drawings and is a direction perpendicular to the first direction. In addition, a third direction corresponds to a Z-axis direction illustrated in the drawings and is a direction perpendicular to the first direction and the second direction.

The pad TP may be a heat transfer member. The pad TP may be located between the second body 160 and the substrate part 150. For example, the pad TP may be located between the protrusion of the second body 160 and the substrate part 150 on which the image sensor IS is seated. Accordingly, the pad TP may overlap the protrusion and the image sensor IS in the optical axis direction (X-axis direction).

In addition, the pad TP may be in contact with the substrate part 150 on which the image sensor IS is seated. For example, the pad TP may be in direct contact with the substrate part 150. Particularly, the pad TP may be in contact with a first substrate of the substrate part 150 or a heat sink attached to the first substrate.

In addition, the pad TP may be in contact with the protrusion of the second body 160. Particularly, the pad TP may be in direct contact with the protrusion of the second body 160.

The coupling members SC1 and SC2 may include screws and bolts. The coupling members SC1 and SC2 may include a first coupling member SC1 and a second coupling member SC2. The substrate part 150 and the first body 130 may be coupled by the first coupling member SC1. The first body 130 and the second body 160 may be coupled by the second coupling member SC2.

In addition, sealing members SE may surround the connecting terminals. Accordingly, the reliability of the connecting terminals can be improved.

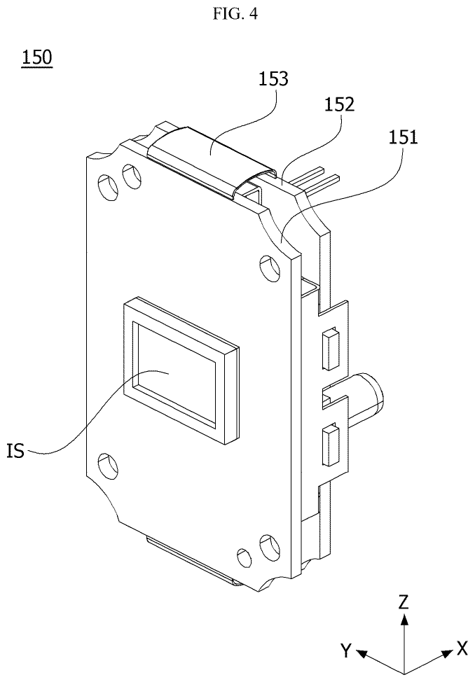

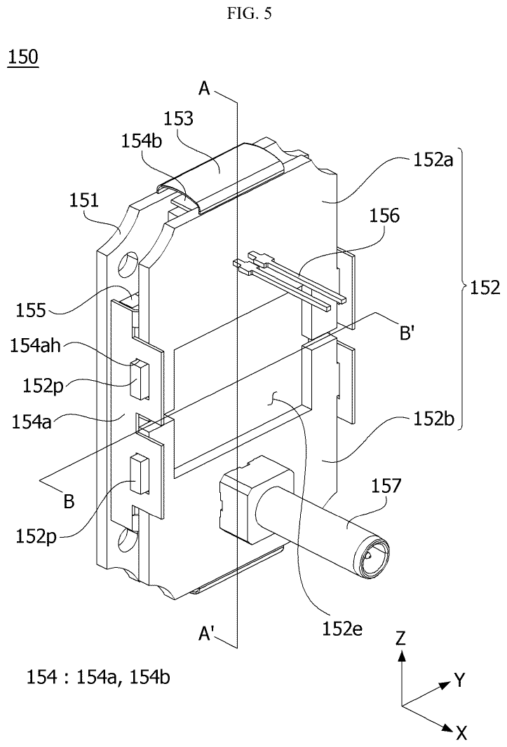

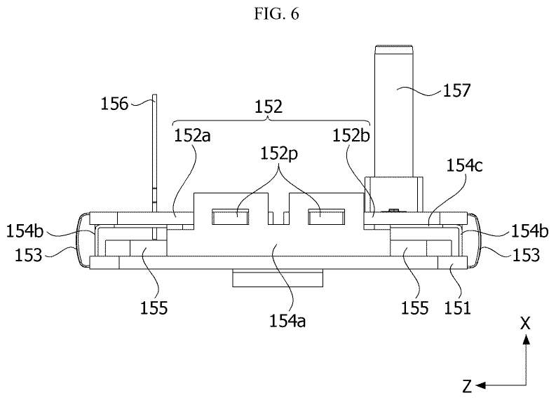

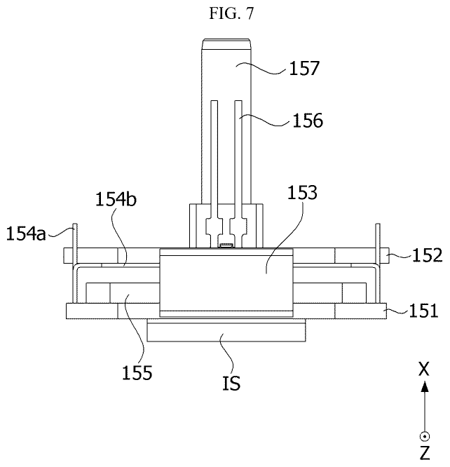

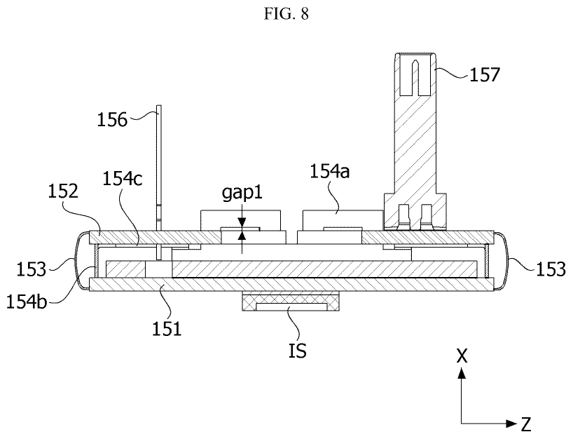

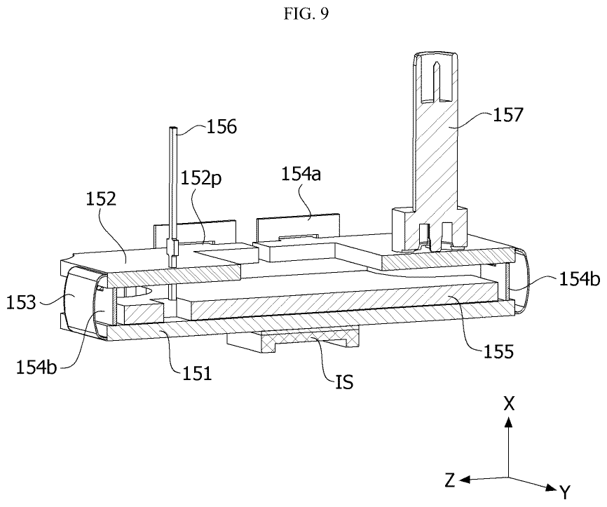

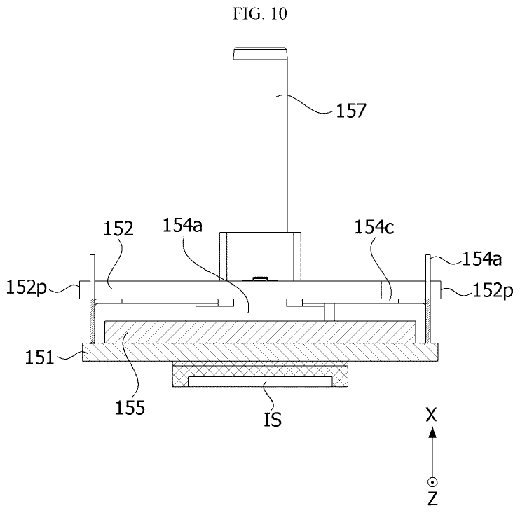

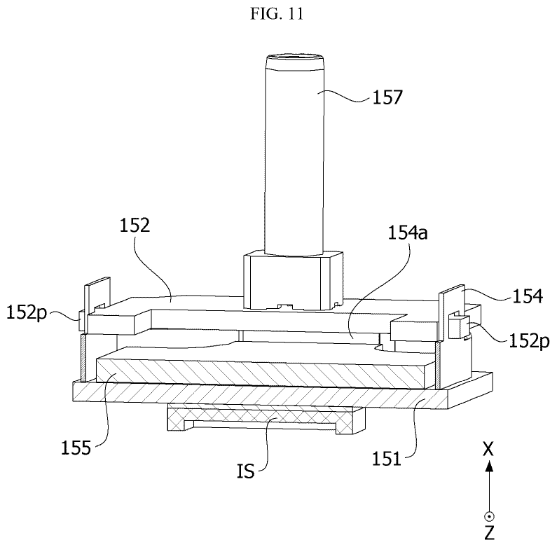

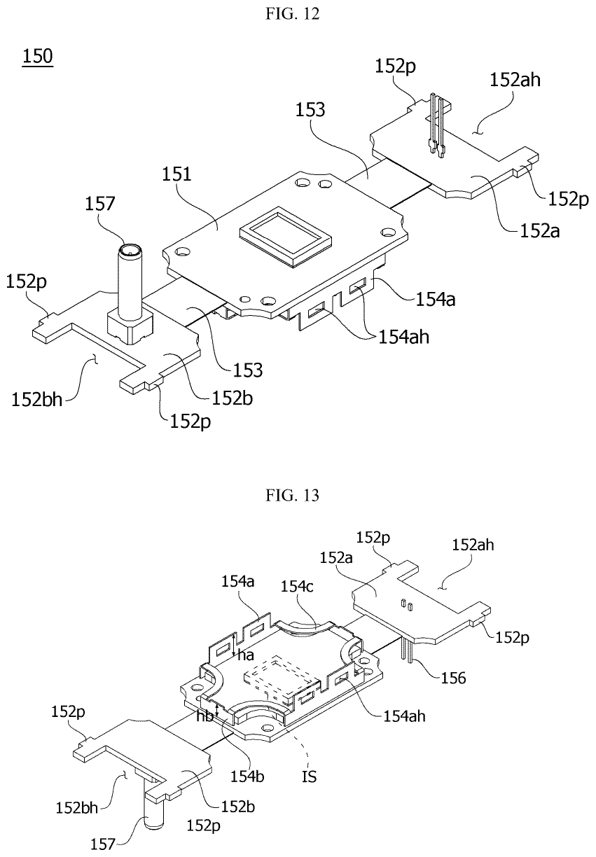

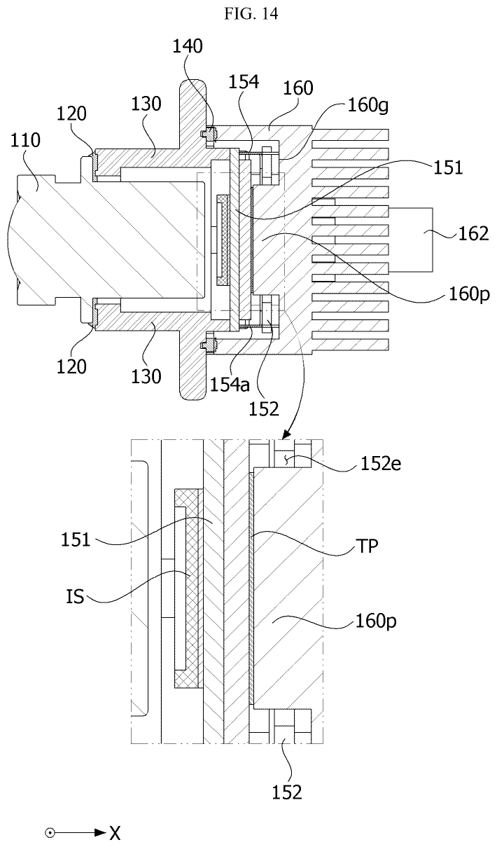

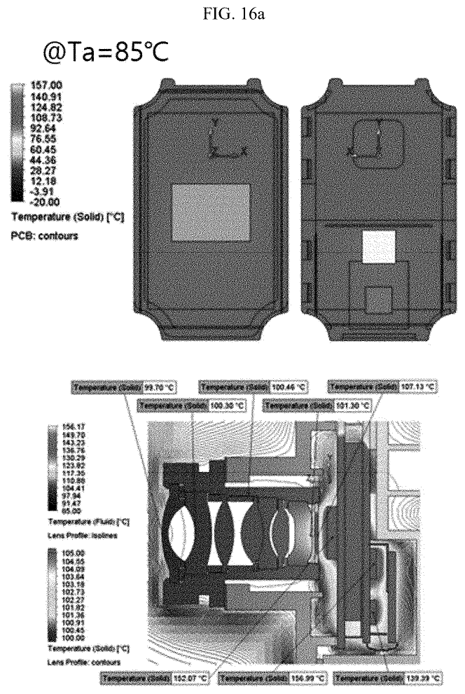

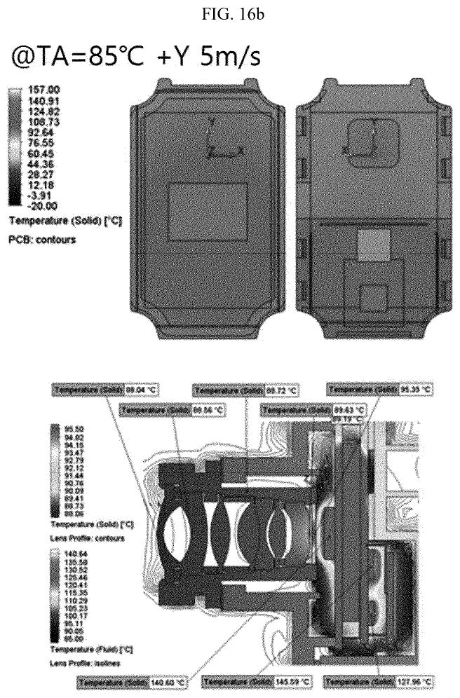

FIG. 4 is one perspective view illustrating the substrate part in the camera module according to the first embodiment, and FIG. 5 is another perspective view illustrating the substrate part in the camera module according to the first embodiment. FIG. 6 is one side view illustrating the substrate part in the camera module according to the first embodiment, and FIG. 7 is another side view illustrating the substrate part in the camera module according to the first embodiment. FIG. 8 is a cross-sectional view along line AA′ in FIG. 5, and FIG. 9 is a perspective view of FIG. 8. FIG. 10 is a cross-sectional view along line BB′ in FIG. 5, and FIG. 11 is a perspective view of FIG. 10. FIG. 12 is a plan view illustrating the substrate part, which is unfolded, in the camera module according to the first embodiment, and FIG. 13 is a bottom view illustrating the substrate part, which is unfolded, in the camera module according to the first embodiment. FIG. 14 is a cross-sectional view illustrating the camera module according to the first embodiment, and FIG. 15 is a perspective view of FIG. 14. FIG. 16 shows views for describing effects of the camera module according to the first embodiment.

Referring to FIGS. 4 to 15, in the camera module 100 according to the first embodiment, the substrate part 150 may include the image sensor IS. In addition, the substrate part 150 may include a first substrate 151 on which the image sensor IS is disposed and a second substrate 152 spaced apart from the first substrate 151. The first substrate 151 and the second substrate 152 may be disposed apart from each other in any of various directions. In the present embodiment, the first substrate 151 and the second substrate 152 may be disposed apart from each other in the optical axis direction. In addition, the first substrate 151 and the second substrate 152 may overlap in the optical axis direction. According to the above-described configuration, a size of the camera module according to the embodiment may be minimized in a direction perpendicular to the optical axis direction. Accordingly, the camera module according to the embodiment may be miniaturized in a specific direction.

In addition, the substrate part 150 may include a connecting part 153 which connects the first substrate 151 and the second substrate 152. The connecting part has a reference numeral which is the same as the above-described substrate but is a different component. Hereinafter, the connecting part and a protection member, the heat sink and the protection member, and the heat sink and the connecting terminal may all be different components. Circuit elements may be disposed on the first substrate 151 and the second substrate 152. In addition, the first substrate 151 and the second substrate 152 may be connected to connecting terminals 156 and 157. For example, various circuit elements, patterns, drivers, etc. may be mounted on the first substrate 151. In addition, the connecting terminals may be disposed on the second substrate 152, and the second substrate 152 may be connected to connecting terminals.

Each of the first substrate 151, the second substrate 152, and the connecting part 153 may be formed as any of various substrates. For example, each of the first substrate 151 and the second substrate 152 may be formed as a flexible printed circuit board, a rigid flexible printed circuit board, or a rigid printed circuit board. In addition, the connecting part 153 may be formed as a flexible printed circuit board. Accordingly, the first substrate 151 and the second substrate 152 may be easily separated or stacked.

In addition, the substrate part 150 may include the connecting part 153. The connecting part 153 may be located at one side between the first substrate 151 and the second substrate 152. For example, the connecting part 153 may be located on outer sides of the first substrate 151 and the second substrate 152. In addition, the connecting part 153 may be provided as a plurality of connecting parts 153. For example, the plurality of connecting parts 153 may be disposed apart from each other in the third direction. In addition, the connecting part 153 may be located to be closer to a second sub-member 154b than a first sub-member 154a which will be described below. In the embodiment, the connecting part 153 may be located on an outer side of the second sub-member 154b. Accordingly, the connecting part 153 may protect the second sub-member 154b. In addition, the first sub-member 154a may be easily located on the outer side of the second substrate 152. Accordingly, the first substrate 151 and the second substrate 152 may be easily assembled using the first sub-member 154a. Detailed description thereof will be described below.

In addition, the substrate part 150 may include a protection member 154 disposed on a side portion of the first substrate 151. In addition, the protection member 154 may be located on an outer side of the second substrate 152. In addition, the protection member 154 may include hole members 154ah. In addition, substrate protrusions 152p may be disposed in the hole members 154ah. In the embodiment, the substrate protrusions 152p may pass through the hole members 154ah. In addition, the second substrate 152 may include the substrate protrusions 152p extending outward.

In addition, the substrate part 150 may include a heat sink 155 disposed on the first substrate 151. The heat sink 155 may be located on a lower surface of the first substrate 151. In addition, the heat sink 155 may provide heat generated from the image sensor IS of the first substrate 151 to the outside. The heat sink 155 may be formed of a metal. For example, the heat sink 155 may be formed of aluminum. For example, the heat sink 155 may be an A1 surface mount technology (SMT) part.

In addition, the substrate part 150 may include the connecting terminals 156 and 157 connected to the second substrate. For example, the connecting terminals may include a first connecting terminal 156 and a second connecting terminal 157. Any one of the first connecting terminal 156 and the second connecting terminal 157 may be a terminal through which data is transmitted and received. In addition, the other of the first connecting terminal 156 and the second connecting terminal 157 may be a terminal through which power (electrical energy) is transmitted and received.

In addition, the second substrate 152 may include a first sub-substrate 152a and a second sub-substrate 152b. The first sub-substrate 152a and the second sub-substrate 152b may be spaced apart from each other in a direction perpendicular to an optical axis on the second substrate 152. Alternatively, the first sub-substrate 152a and the second sub-substrate 152b may be integrally formed. However, as in the embodiment, the first sub-substrate 152a and the second sub-substrate 152b may be disposed apart from each other in the direction perpendicular to the optical axis (for example, in the third direction) and easily assembled and connected to the first and second connecting terminals. In addition, the first sub-substrate 152a and the second sub-substrate 152b may be easily stacked on the first substrate 151.

In addition, the second substrate 152 may include a hole 152e through which the protrusion 160p passes. For example, the hole 152e or a substrate hole may be a hole formed by a sub-groove or sub-hole 152ah of the first sub-substrate 152a and a sub-groove or sub-hole 152bh of the second sub-substrate 152b. The first substrate 151 may be exposed through the hole. The groove 152e may overlap the first substrate 151 in the optical axis direction. In addition, the groove 152e may also overlap the image sensor IS in the optical axis direction. In addition, an area of the groove 152e may be greater than an area of the image sensor IS in order to improve a heat dissipation effect. The second substrate 152 may not overlap the image sensor IS in the optical axis direction due to the groove 15e.

The protrusion 160p may pass through the groove 152e and may be located adjacent to the first substrate 151. The protrusion 160p may be in contact with the first substrate 151. As additionally described above, the heat sink 155 may be disposed on the first substrate 151. Accordingly, the protrusion 160p may be in contact with the heat sink 155. Alternatively, the pad TP may be disposed between the protrusion 160p and the heat sink 155. Accordingly, heat emitted from the image sensor IS may be transferred to the first substrate 151, the heat sink 155, the pad TP, and the protrusion 160P. Accordingly, even when the first substrate and the second substrate are formed as a stack structure, reduction of heat dissipation due to a fluid (air) present in the camera module may be easily prevented. In other words, the heat dissipation performance of the camera module may be improved. Therefore, according to the embodiment, the camera module with improved heat dissipation performance and reliability can be provided.

In addition, the image sensor IS, the first substrate 151, the heat sink 155, the pad TP, and the protrusion 160p may overlap in the optical axis direction in order to further improve heat dissipation. As described above, the pad TP may be in contact with the first substrate 151 and the protrusion 160p to effectively transfer heat from the substrate part 150 to the second body 160.

In addition, as the protrusion 160p passes through the second substrate 152 as described above, the camera module can be compact.

In addition, specifically, as described above, the substrate part 150 may include the protection member 154 disposed on a side surface of the first substrate 151 or a side surface of the second substrate 152. The protection member 154 may correspond to a shield can. Accordingly, the protection member 154 may serve to protect an element on the substrate part 150.

In addition, the protection member 154 according to the embodiment may include the first sub-member 154a, the second sub-member 154b, and a third sub-member 154c.

The first sub-member 154a may be located on an outer side of the second substrate 152. In addition, the substrate protrusions 152p protruding outward from the second substrate 152 may pass through the first sub-member 154a. In the embodiment, the first sub-member 154a may include the hole members 154ah. For example, the substrate protrusions 152p of the first sub-substrate 152a and the second sub-substrate 152b may be located in the hole members 154ah. Alternatively, the substrate protrusions 152p of the first sub-substrate 152a and the second sub-substrate 152b may pass through the hole members 154ah.

The second sub-member 154b may be spaced apart from the first sub-member 154a.

In addition, the third sub-member 154c may be disposed between the first sub-member 154a and the second sub-member 154b. The third sub-member 154c may connect the first sub-member 154a to the second sub-member 154b.

The second sub-member 154b and the third sub-member 154c may be located between the second substrate 152 and the first substrate 151. The second sub-member 154b and the third sub-member 154c may overlap the first substrate 151 and the second substrate 152 in the optical axis direction. Accordingly, the second sub-member 154b and the third sub-member 154c may support the second substrate 152 on the first substrate 151. That is, the second sub-member 154b and the third sub-member 154c may guide a location of the second substrate 152 on the first substrate 151.

In addition, the first sub-member 154a or the second sub-member 154b may be disposed on the outer side of the first substrate 151. Accordingly, the protection member 154 and the second substrate 152 may be coupled.

More specifically, the second substrate 152 may include the substrate protrusions 152p extending outward as described above. The substrate protrusions 152p may be disposed apart from the connecting part 153. According to the above-described configuration, a size of the substrate part 150 may be minimized.

In addition, the first sub-member 154a may have hole members 154ah and 154bh through which the substrate protrusions 152p pass, and each of the hole members may have an area which is greater than an area of each of the substrate protrusions 152p.

That is, the substrate protrusions 152p may have predetermined separation distance gaps from the hole members 154ah and 154bh. Alternatively, the substrate protrusions 152p may be disposed to be spaced predetermined gaps from portions of inner surfaces of the hole members 154ah and 154bh. According to the above-described configuration, when a connecting terminal of the camera module and an external device are connected, damage to the substrate part may be suppressed. In addition, the camera module may be easily assembled with another device.

The substrate part 150 may include the connecting terminals electrically connected to the first substrate, the second substrate, and the like. As described above, the connecting terminals may include the first connecting terminal 156 and the second connecting terminal 157. In addition, the connecting terminals according to the embodiment may have a structure extending in the optical axis direction.

As described above, the camera module 100 according to the first embodiment may effectively dissipate heat generated by the image sensor IS. In addition, even when the first substrate and the second substrate are stacked, and a fluid (for example, air) layer is present between the first substrate and the second substrate, heat may be easily dissipated through the protrusion. In addition, the camera module according to the embodiment has a structure in which the second substrate is stacked on the first substrate using the connecting part in the optical axis direction. Accordingly, as the substrate part has a bent structure, an area or size thereof may be decreased in the direction perpendicular to the optical axis direction.

Referring to FIG. 16, Table 1 below is a table showing heating performance of each of a structure (Comparative Example) in which heat dissipation through a protrusion is not performed and the camera module according to the present invention. In addition, FIG. 16A is a view showing a result of a simulation for testing a heat dissipation effect in Comparative Example, and FIG. 16B is a view showing a result of a simulation for testing a heat dissipation effect in Example.

TABLE 1

| Comparative Example | | | Example | | |
|---|---|---|---|---|---|
| | | Est. | | | Est. |
| Est. | Est. | Tj [° C.] | Est. | Est. | Tj [° C.] |
| Tj [° C.] | Tj [° C.] | @85° C., | Tj [° C.] | Tj [° C.] | @85° C., |
| @25° C. | @85° C. | 5 m/s | @25° C. | @85° C. | 5 m/s |
| 98.07 | 152.07 | 140.6 | 78.16 | 133.27 | 121.03 |
| 102.89 | 156.99 | 145.59 | 82.01 | 136.83 | 124.53 |
| 85.13 | 139.39 | 127.96 | 67.82 | 123.09 | 110.72 |

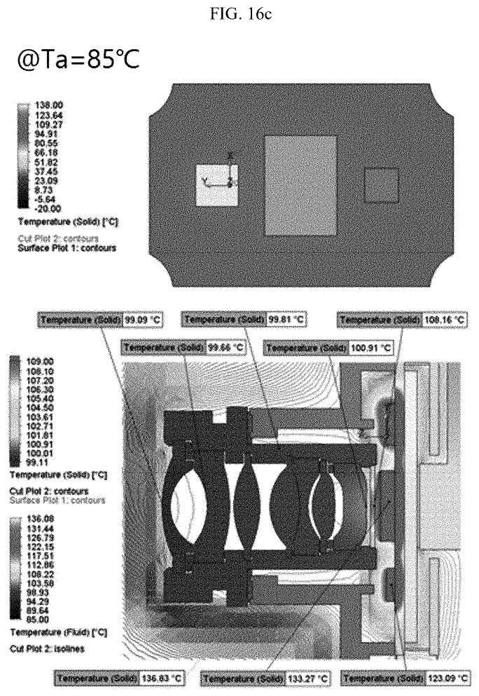

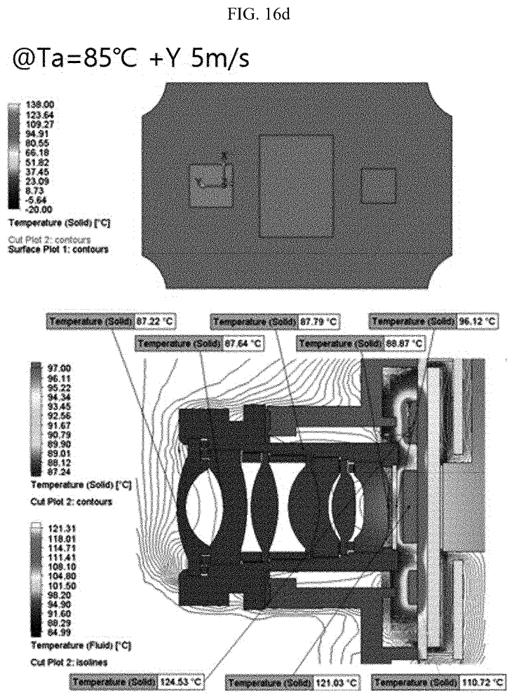

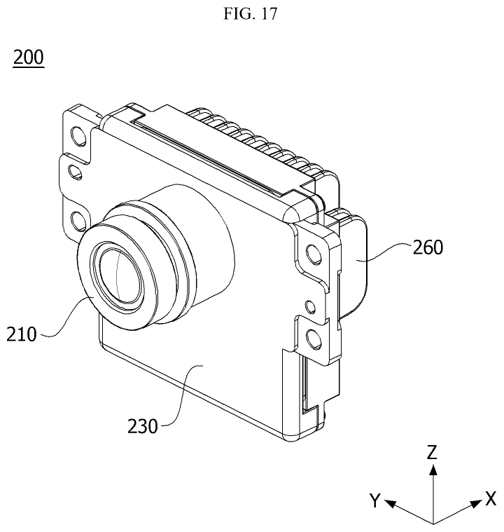

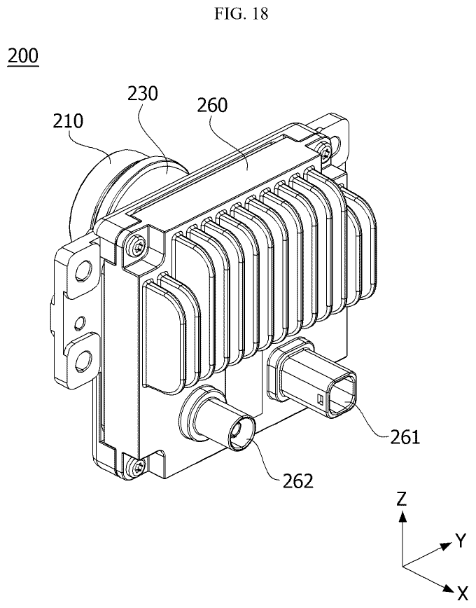

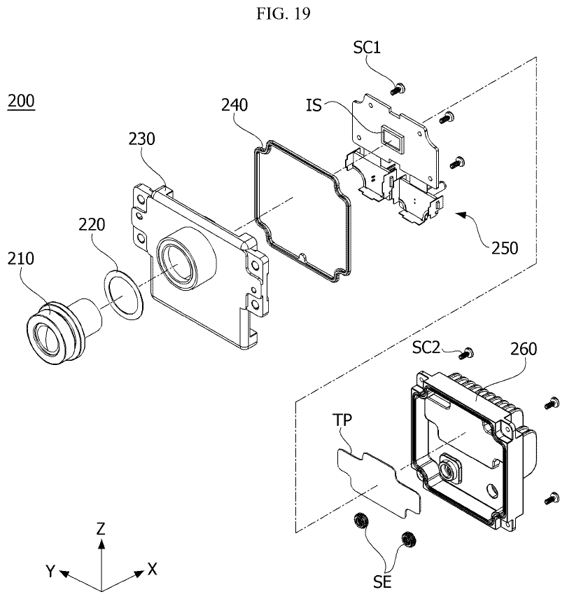

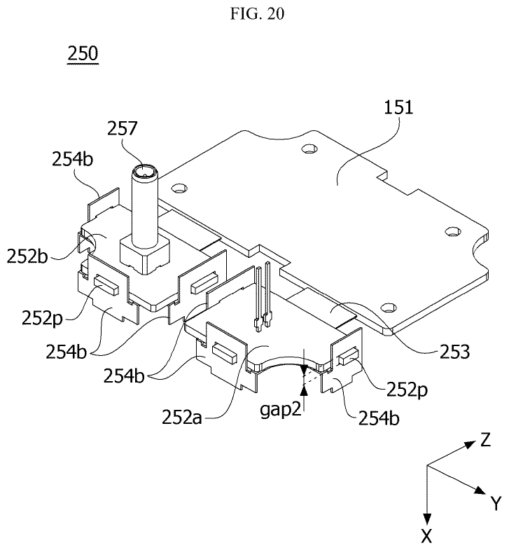

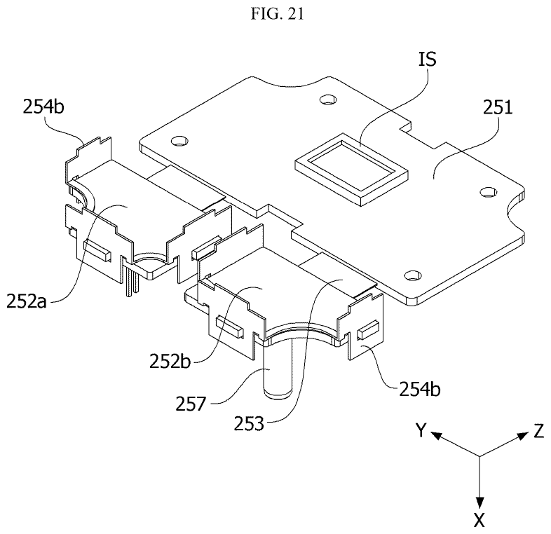

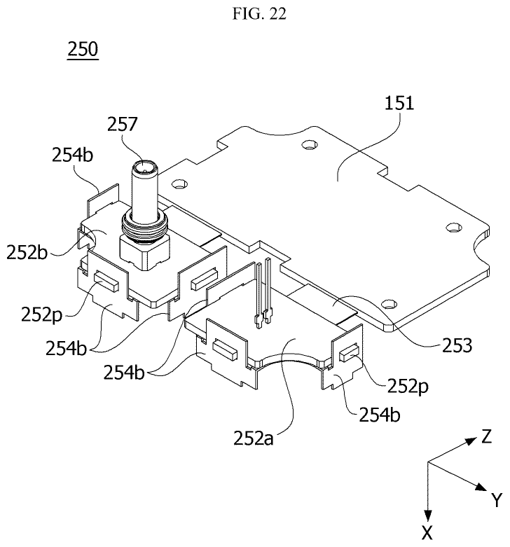

Here, Est. Tj [° C.] means a maximum temperature of a camera module. In addition, @25° C. means a temperature of an image sensor. In addition, @85° C. means a case in which a temperature of the image sensor is 85° C. In addition, in @85° C. and 5 m/s, ‘5 m/s’ means a wind speed of an external fluid of the camera module. As described above, the camera module according to the embodiment provides an effect of decreasing heating by 14% compared to Comparative Example in which the heat dissipation through the protrusion is not performed. Accordingly, the camera module according to the embodiment may provide a high reliability and high efficiency heat dissipation effect. FIG. 17 is one perspective view illustrating a camera module according to a second embodiment, and FIG. 18 is another perspective view illustrating the camera module according to the second embodiment. FIG. 19 is an exploded perspective view illustrating the camera module according to the second embodiment, and FIG. 20 is a perspective view illustrating a substrate part in the camera module according to the second embodiment. FIG. 21 is a plan view illustrating the substrate part in the camera module according to the second embodiment, and FIG. 22 is a bottom view illustrating the substrate part in the camera module according to the second embodiment. FIG. 23 is a perspective view illustrating the substrate part and a first body in the camera module according to the second embodiment, and FIG. 24 is a cross-sectional view illustrating the camera module according to the second embodiment.

A camera module 200 according to the second embodiment includes components corresponding to the above-described camera module according to the first embodiment, and the same description excluding the following description will be applied thereto.

Specifically, a lens assembly 210 may be located at one end of the camera module 200. For example, the lens assembly 210 may be located at a front end of the camera module 200. The lens assembly 210 may include a plurality of lenses. For example, light incident on the camera module 200 in a vehicle may pass through the plurality of lenses. Various members (for example, a cover glass, a cover, a spacer, etc.) may be further present in the lens assembly 210 such that at least one lens is mounted on the lens assembly 210.

Referring to FIGS. 17 to 24, like the above-described content, a first body 230 may be connected to the lens assembly 210. The first body 230 may be coupled to the lens assembly 210. A bonding member 220 may be disposed between the first body 230 and the lens assembly 210. The bonding member 220 may be formed of a resin such as epoxy to allow the lens assembly to variously perform active alignment. For example, the lens assembly 210 may move in the first body 230, and then the bonding member 220 may be cured by heat or the like for the active alignment with an image sensor IS in the camera module 200. Accordingly, the first body 230 and the lens assembly 210 may be coupled to each other through the bonding member 220.

The first body 230 may include a hole, and a portion of the lens assembly 210 may be located in the hole. In addition, the first body 230 may be connected to a second body 260 to form an empty space therein. A gasket 240, a substrate part 250, the image sensor IS, and the like may be disposed in the empty space.

The first body 230 may have any of various structures to be coupled with the substrate part 250 or the second body 260. For example, the first body 230 may be screw-coupled to the substrate part 250 or the second body 260. To this end, the first body 230 may include a groove or hole for screw-coupling.

The gasket 240 may be located under the first body 230. In addition, the gasket 240 may be located between the first body 230 and the second body 260. The gasket 240 may suppress foreign matter from being introduced into the first body 230 and the second body 260. To this end, the gasket 240 may be located along an edge of the first body 230.

The substrate part 250 may be located between the first body 230 and the second body 260 which are spaced apart from each other. Alternatively, the substrate part 250 may be located in the internal space formed by the first body 230 and the second body 260.

The substrate part 250 may include circuit elements and a pattern for connecting the elements. In addition, the image sensor IS may be mounted on the substrate part 250. That is, the image sensor IS may be disposed on the substrate part 250. Accordingly, the image sensor IS may also be located on the second body 260 or the first body 230. The image sensor IS may be a separate component disposed on the substrate part 250, but hereinafter, it will be described that the image sensor IS is included in the substrate part 250. In addition, the image sensor IS may include various devices which convert an optical signal into an electrical signal.

The second body 260 may include connectors 261 and 262. For example, the second body 260 may include a first connector 261 and a second connector 262 which protrude outward. The first connector 261 and the second connector 262 may surround first and second connecting terminals which will be described below when the substrate part 250 is described. That is, the connectors may protect the connecting terminals of the substrate part 250. Accordingly, the camera module according to the embodiment may be connected to an external device (for example, a vehicle, or a controller in a vehicle). Accordingly, the camera module may receive power or data. In addition, the camera module may perform a predetermined operation using a driver IC, a processor, or a controller disposed on the substrate part 250 in the camera module.

In addition, the second body 260 may include an inner groove 260g (see FIG. 24). The substrate part 250 may be located in the inner groove. In addition, the second body 260 may include a protrusion 260p (see FIG. 24) protruding from the inner groove toward the image sensor IS or the substrate part 250. The protrusion may be connected to the image sensor IS and overlap the image sensor IS in an optical axis direction. According to the above-described configuration, heat generated from the image sensor IS may be easily dispersed through the second body. In addition, the heat generated from the image sensor IS may be transferred to the second body and dissipated to the outside. Accordingly, the durability or reliability of the camera module 200 according to the embodiment can be improved.

In addition, the optical axis direction may correspond to a first direction (X-axis direction). The optical axis direction may correspond to a direction in which light is incident on the image sensor. That is, the optical axis direction may be a direction toward the image sensor in the lens assembly. In addition, the optical axis direction may be a separation direction between the first body and the second body. In addition, a second direction corresponds to a Y-axis direction illustrated in the drawings and is a direction perpendicular to the first direction. In addition, a third direction corresponds to a Z-axis direction illustrated in the drawings and is a direction perpendicular to the first direction and the second direction.

A pad TP may be a heat transfer member. The pad TP may be located between the second body 260 and the substrate part 250. For example, the pad TP may be located between the protrusion of the second body 260 and the substrate part 250 on which the image sensor IS is seated. Accordingly, the pad TP may overlap the protrusion and the image sensor IS in the optical axis direction (X-axis direction).

In addition, the pad TP may be in contact with the substrate part 250 on which the image sensor IS is seated. For example, the pad TP may be in direct contact with the substrate part 250. Particularly, the pad TP may be in contact with a first substrate of the substrate part 250 or a heat sink attached to the first substrate.

In addition, the pad TP may be in contact with the protrusion of the second body 260. Particularly, the pad TP may be in direct contact with the protrusion of the second body 260.

The pad TP may have an area corresponding to an area of the protrusion 260p of the second body 260. In addition, the area of the pad TP may be greater than an area of the image sensor IS. Accordingly, heat generated from the image sensor IS may be effectively dissipated through the pad TP and the second body 260.

Coupling members SC1 and SC2 may include screws and bolts. The coupling members SC1 and SC2 may include a first coupling member SC1 and a second coupling member SC2. The substrate part 250 and the first body 230 may be coupled by the first coupling member SC1. The first body 230 and the second body 260 may be coupled by the second coupling member SC2.

In addition, sealing members SE may surround the connecting terminals. Accordingly, the reliability of the connecting terminals can be improved.

In the camera module 200 according to the second embodiment, the substrate part 250 may include the image sensor IS. In addition, the substrate part 250 may include a first substrate 251 on which the image sensor IS is disposed and a second substrate 252 spaced apart from the first substrate 251. The first substrate 251 and the second substrate 252 may be disposed apart from each other in any of various directions. In the present embodiment, the first substrate 251 and the second substrate 252 may be disposed apart from each other in a direction perpendicular to the optical axis direction.

For example, the first substrate 251 and the second substrate 252 may overlap in the third direction (Z-axis direction). In addition, the first substrate 251 and the second substrate 252 may not overlap in the optical axis direction. According to the above-described configuration, a size of the camera module according to the embodiment may be minimized in the direction perpendicular to the optical axis direction. Accordingly, the camera module according to the embodiment may be miniaturized in a specific direction. A thickness of the camera module according to the second embodiment may decrease in the optical axis direction.

In addition, the substrate part 250 may include a connecting part 253 which connects the first substrate 251 and the second substrate 252. Circuit elements may be disposed on the first substrate 251 and the second substrate 252. In addition, the first substrate 251 and the second substrate 252 may be connected to connecting terminals 256 and 257. For example, various circuit elements, patterns, drivers, etc. may be mounted on the first substrate 251. In addition, the connecting terminals may be disposed on the second substrate 252, and the second substrate 252 may be connected to the connecting terminal.

Each of the first substrate 251, the second substrate 252, and the connecting part 253 may be formed as any of various substrates. For example, each of the first substrate 251 and the second substrate 252 may be formed as a flexible printed circuit board, a rigid flexible printed circuit board, or a rigid printed circuit board. In addition, the connecting part 253 may be formed as a flexible printed circuit board. Accordingly, the first substrate 251 and the second substrate 252 may be easily spaced apart from each other.

In addition, the substrate part 250 may include the connecting part 253. The connecting part 253 may be located at one side between the first substrate 251 and the second substrate 252. For example, the connecting part 253 may be located on outer sides of the first substrate 251 and the second substrate 252. In addition, the connecting part 253 may be provided as a plurality of connecting parts 253. For example, the plurality of connecting parts 253 may be disposed apart from each other in the third direction.

In addition, the substrate part 250 may include a protection member 254 disposed on a side portion of the first substrate 251. In addition, the protection member 254 may be located on an outer side of the second substrate 252. In addition, the protection member 254 may include hole members 254ah and 254ah. In addition, substrate protrusions 252p may be disposed in the hole members 254ah. In the embodiment, the substrate protrusions 252p may pass through the hole members 254ah. In this case, the second substrate 252 may include the substrate protrusions 252p extending outward.

In addition, the substrate part 250 may include a heat sink (not shown) disposed on the first substrate 251. The heat sink may be located on a lower surface of the first substrate 251. In addition, the heat sink may provide heat generated from the image sensor IS of the first substrate 251 to the outside. The heat sink may be formed of a metal. For example, the heat sink may be formed of aluminum.

In addition, the substrate part 250 may include the connecting terminals 256 and 257 connected to the second substrate. For example, the connecting terminals may include a first connecting terminal 256 and a second connecting terminal 257. Any one of the first connecting terminal 256 and the second connecting terminal 257 may be a terminal through which data is transmitted and received. In addition, the other of the first connecting terminal 256 and the second connecting terminal 257 may be a terminal through which power (electrical energy) is transmitted and received.

In addition, the second substrate 252 may include a first sub-substrate 252a and a second sub-substrate 252b. The first sub-substrate 252a and the second sub-substrate 252b may be spaced apart from each other in a direction perpendicular to an optical axis on the second substrate 252. Alternatively, the first sub-substrate 252a and the second sub-substrate 252b may be integrally formed. However, as in the embodiment, the first sub-substrate 252a and the second sub-substrate 252b may be disposed apart from each other in the direction perpendicular to the optical axis (for example, in the third direction) and easily assembled and connected to the first and second connecting terminals. In addition, the first sub-substrate 252a and the second sub-substrate 252b may be easily stacked on the first substrate 251.

In addition, the second substrate 252 may not overlap the protrusion 260p in the optical axis direction. That is, the second substrate 252 may be disposed to not intersect the protrusion 260p. In the present embodiment, since the first and second connecting terminals 256 and 257 are mounted on the second substrate 252, the second substrate 252 may also not overlap the image sensor IS in the optical axis direction.

In addition, the protrusion 260p may be in contact with the first substrate 251. As additionally described above, the heat sink may be disposed on the first substrate 251. Accordingly, the protrusion 260p may be in contact with the heat sink. Alternatively, the pad TP may be disposed between the protrusion 260p and the heat sink. Accordingly, heat emitted from the image sensor IS may be transferred to the first substrate 251, the heat sink, the pad TP, and the protrusion 260P. Accordingly, even when the first substrate and the second substrate are formed as a stack structure, reduction of heat dissipation due to a fluid (air) present in the camera module may be easily prevented. In other words, the heat dissipation performance of the camera module may be improved. Therefore, according to the embodiment, the camera module with improved heat dissipation performance and reliability can be provided.

In addition, the image sensor IS, the first substrate 251, the heat sink, the pad TP, and the protrusion 260p may overlap in the optical axis direction in order to further improve heat dissipation. As described above, the pad TP may be in contact with the first substrate 251 and the protrusion 260p to effectively transfer heat from the substrate part 250 to the second body 260.

In addition, as the protrusion 260p passes through the second substrate 252 as described above, the camera module can be compact.

In addition, specifically, the substrate part 250 may include the protection member 254 disposed the side portion of the first substrate 251 as described above, or on a side surface of the second substrate 252. The protection member 254 may correspond to a shield can. Accordingly, the protection member 254 may serve to protect an element on the substrate part 250.

In addition, the protection member 254 according to the embodiment may include a first sub-member 254a and a second sub-member 254b.

The first sub-member 254a may be located on an outer side of the first substrate 251. In addition, the first sub-member 254a may be located adjacent to the first substrate 251. In addition, the substrate protrusions 252p protruding outward from the second substrate 252 may pass through the first sub-member 254a. In the embodiment, the first sub-member 254a may include the hole members 254ah. For example, the substrate protrusions 252p of the first sub-substrate 252a and the second sub-substrate 252b may be located in the hole members 254ah. Particularly, the substrate protrusions of the first sub-substrate 252a may be located in the hole members 254ah. In addition, the substrate protrusions of the second sub-substrate 252b may be located in the hole members 254bh. Alternatively, the substrate protrusions 252p of the first sub-substrate 252a and the second sub-substrate 252b may pass through the hole members 254ah. In addition, an area of each of the hole members 254ah and 254bh and an area of each of the substrate protrusion 252p may be different from each other. For example, the area of the hole member may be greater than the area of the substrate protrusion.

In addition, the second sub-member 254b may be spaced apart from the first sub-member 254a. In addition, the first sub-member 254a or the second sub-member 254b may be disposed on an outer side of the second substrate 252. In addition, the protection member 254 may be seated in a groove or body groove formed in an inner surface of the first body 230. That is, the protection member 254 may be connected to the second substrate through the hole member and connected to the first body through the body groove of the first body 230. Accordingly, the protection member 254 and the second substrate 252 may be coupled.

More specifically, as described above, the second substrate 252 may include the substrate protrusions 252p extending outward as described above. The substrate protrusions 252p may be disposed apart from the connecting part 253. According to the above-described configuration, a size of the substrate part 250 may be miniaturized.

In addition, the first sub-member 254a may include the hole members 254ah and 254bh through which the substrate protrusions 252p pass, and the hole member may have the area which is greater than the area of the substrate protrusion 252p.

That is, the substrate protrusions 252p may have predetermined separation distance gaps2 from the hole members 254ah and 254bh. Alternatively, the substrate protrusions 252p may be disposed to be spaced predetermined distance gaps from portions of inner surfaces of the hole members 254ah and 254bh. According to the above-described configuration, when the connecting terminal of the camera module and an external device are connected, damage to the substrate part can be suppressed. In addition, the camera module may be easily assembled with another device.

In addition, the substrate part 250 may include the connecting terminals 256 and 257 electrically connected to the first substrate, the second substrate, and the like. As described above, the connecting terminals may include the first connecting terminal 256 and the second connecting terminal 257. In addition, the connecting terminals according to the embodiment may have a structure extending in the optical axis direction.

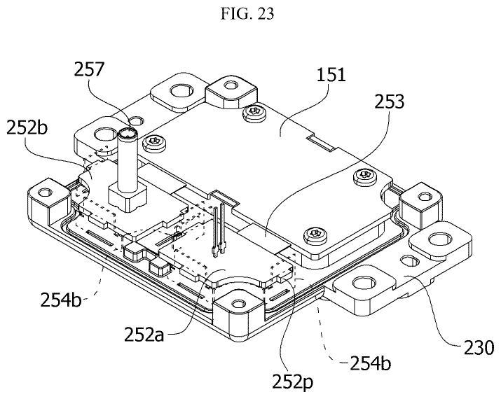

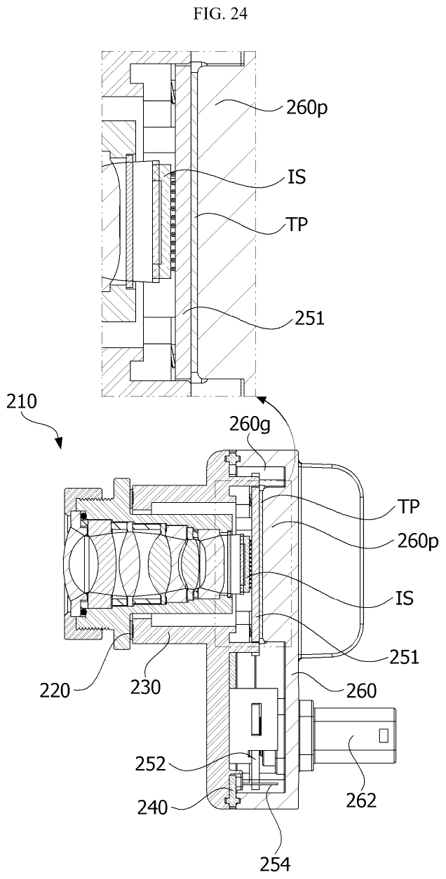

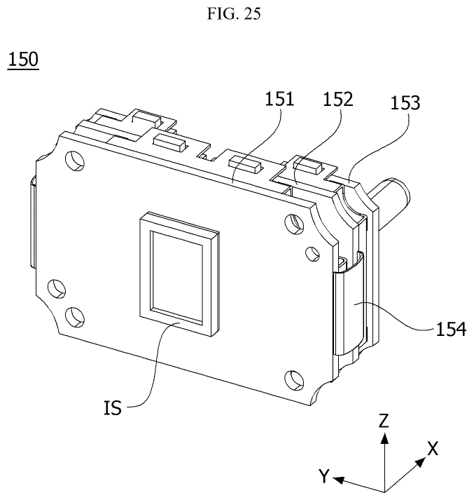

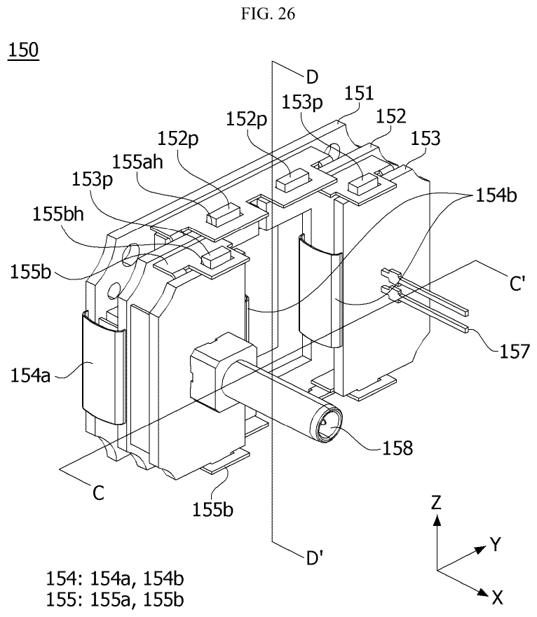

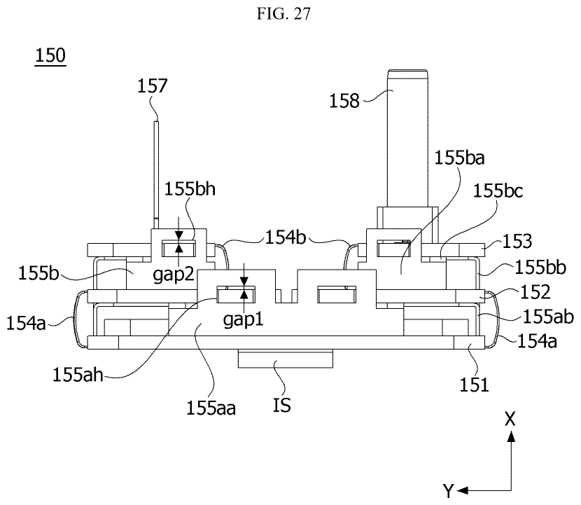

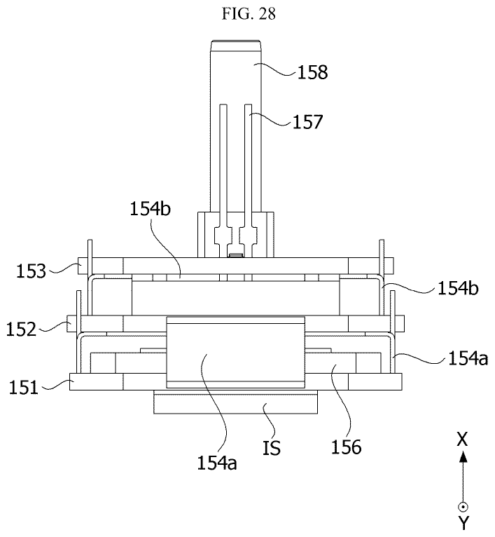

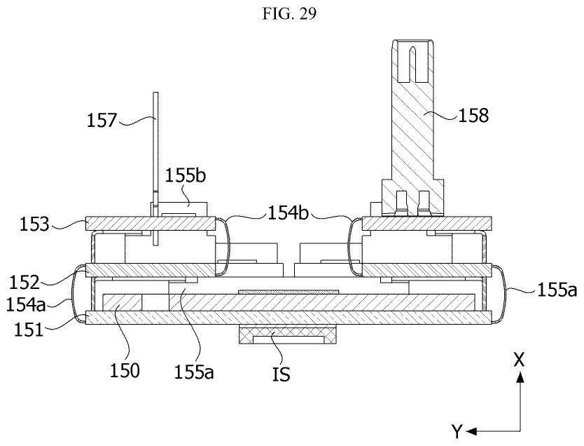

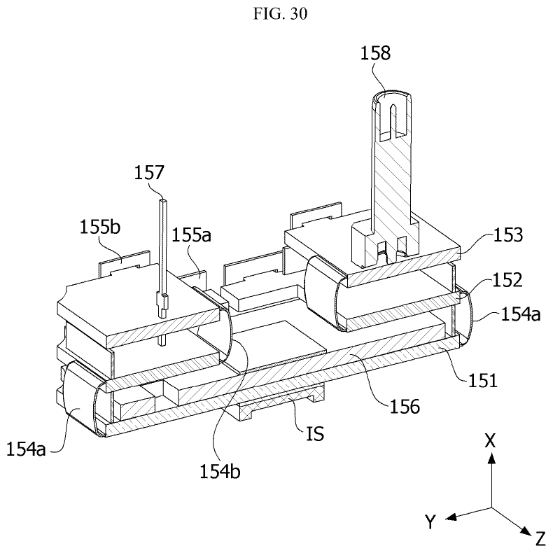

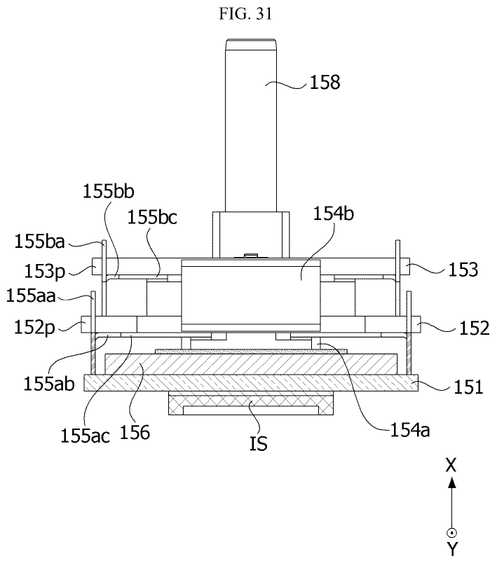

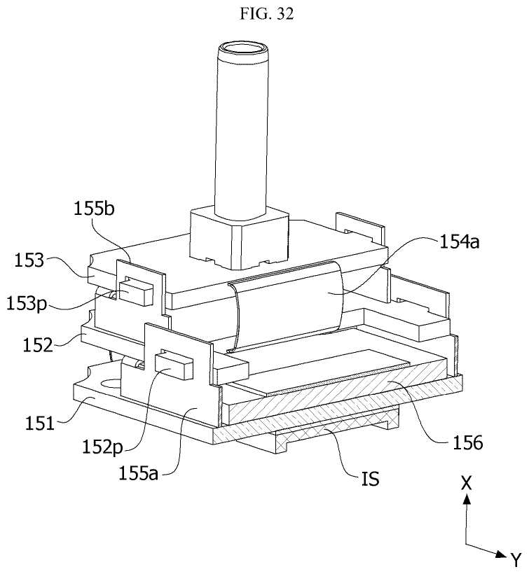

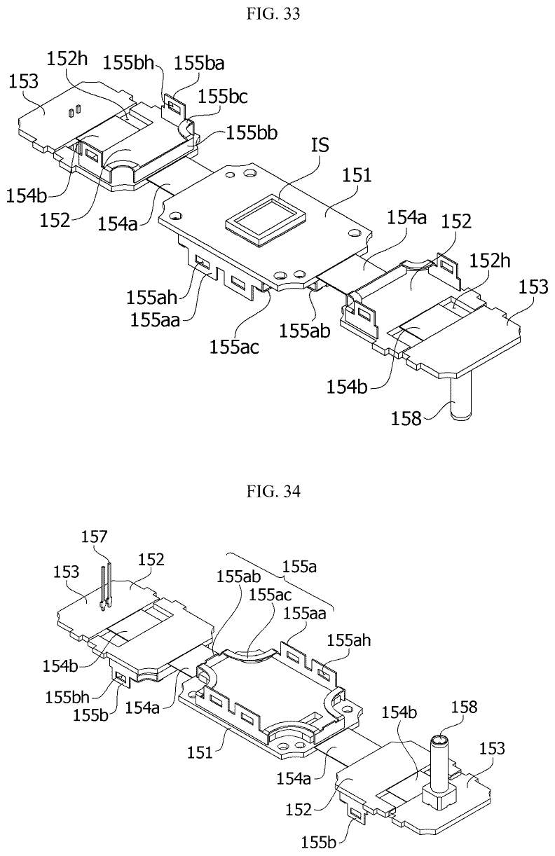

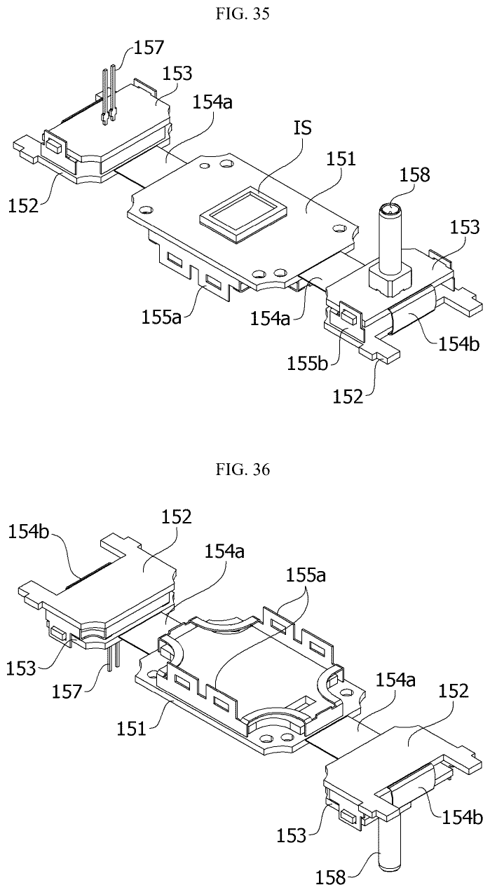

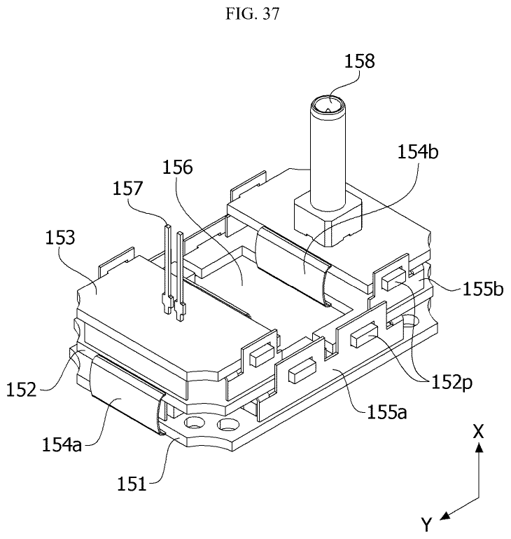

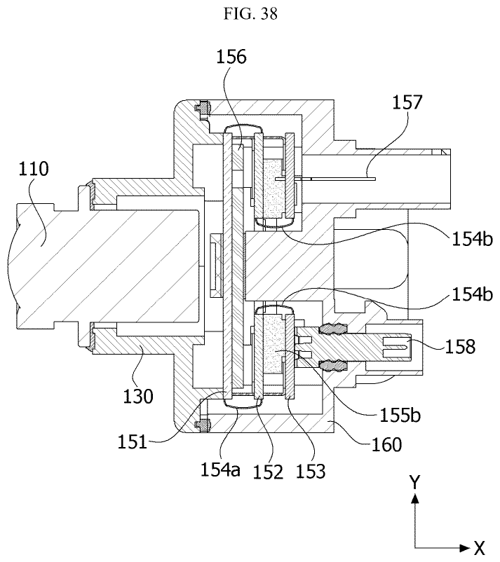

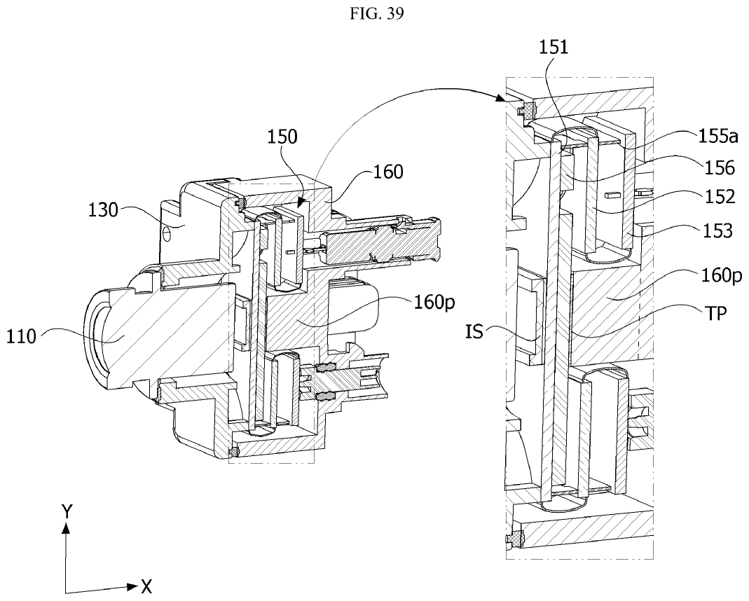

FIG. 25 is one perspective view illustrating a substrate part in a camera module according to a third embodiment, and FIG. 26 is another perspective view illustrating the substrate part in the camera module according to the third embodiment. FIG. 27 is one side view illustrating the substrate part in the camera module according to the third embodiment, and FIG. 28 is another side view illustrating the substrate part in the camera module according to the third embodiment. FIG. 29 is a cross-sectional view along line CC′ in FIG. 26, and FIG. 30 is a perspective view of FIG. 29, and FIG. 31 is a cross-sectional view along line DD′ in FIG. 26. FIG. 32 is a perspective view of FIG. 31, and FIG. 33 is a plan view illustrating the substrate part, which is unfolded, in the camera module according to the third embodiment. FIG. 34 is a bottom view illustrating the substrate part, which is unfolded, in the camera module according to the third embodiment, and FIG. 35 is a plan view illustrating the substrate part, of which a portion is folded, in the camera module according to the third embodiment. FIG. 36 is a bottom view illustrating the substrate part, of which the portion is folded, in the camera module according to the third embodiment, and FIG. 37 is a plan view illustrating the substrate part, which is folded completely, in the camera module according to the third embodiment. FIG. 38 is a cross-sectional view illustrating the camera module according to the third embodiment, and FIG. 39 is a perspective view of FIG. 38.

Referring to FIGS. 25 to 39, in a camera module 100 according to the third embodiment, a substrate part 150 may include an image sensor IS. In addition, the substrate part 150 may include a first substrate 151 on which the image sensor IS is disposed, a second substrate 152 spaced apart from the first substrate 151, and a third substrate 153 disposed apart from the second substrate 152.

The first substrate 151, the second substrate 152, and the third substrate 153 may be disposed apart from each other in any of various directions. In the present embodiment, the first substrate 151 and the second substrate 152 may be disposed apart from each other in an optical axis direction. The second substrate 152 and the third substrate 153 may be disposed apart from each other in the optical axis direction (X-axis direction). In addition, the first substrate 151 and the second substrate 152 may overlap in the optical axis direction. The second substrate 152 and the third substrate 153 may overlap in the optical axis direction. In addition, the second substrate 152 may be disposed between the first substrate 151 and the third substrate 153. According to the above-described configuration, a size of the camera module according to the embodiment may be minimized in a direction perpendicular to the optical axis direction. In addition, a space in which a plurality of circuit elements mounted on the substrate part 150 having substrates stacked as a plurality of layers may be easily secured. Accordingly, a size can be minimized in a specific direction.

In addition, an above-described protrusion may pass through at least one of the second substrate 152 and the third substrate 153. Detailed description thereof will be described below.

In addition, the substrate part 150 may include a connecting part 154 which connects the first substrate 151 and the second substrate 152 or connects the second substrate 152 and the third substrate 153. Circuit elements may be disposed on the first substrate 151 to the third substrate 153. In addition, the first substrate 151 to the third substrate 153 may be connected to connecting terminals 157 and 158. For example, various circuit elements, patterns, drivers, etc. may be mounted on the first substrate 151 to the third substrate 153. In addition, the connecting terminals may be disposed on the third substrate 153, and the third substrate 153 may be connected to the connecting terminals.

Each of the first substrate 151, the second substrate 152, the third substrate 153, and the connecting part 154 may be formed as any of various substrates. For example, each of the first substrate 151 to the third substrate 153 may be formed as a flexible printed circuit board, a rigid flexible printed circuit board, or a rigid printed circuit board. In addition, the connecting part 154 may be formed as a flexible printed circuit board. Accordingly, the first substrate 151 to the third substrate 153 may be easily spaced apart from each other or stacked on each other.

In addition, the substrate part 150 may include the connecting part 154. The connecting part 154 may include a first connecting part 154a and a second connecting part 154b. The first connecting part 154a may be located at one side between the first substrate 151 and the second substrate 152. The second connecting part 154b may be located at the other side between the second substrate 152 and the third substrate 153. For example, the connecting part 154 may be located on an outer side of the first substrate 151 to the third substrate 153. In addition, the connecting part 154 may be provided as a plurality of connecting parts 154. For example, the plurality of connecting parts 154 may be disposed apart from each other in a second direction. In addition, the connecting part 154 may be located adjacent to a second sub-member 155ab than a first sub-member 155aa which will be described below. In the embodiment, the connecting part 154 may be located outside the second sub-member 155ab. Accordingly, the connecting part 154 may protect the second sub-member 155ab. In addition, the first sub-member 155aa may be easily located on an outer side of the second substrate 152. Accordingly, the first substrate 151 and the second substrate 152 may be easily assembled using the first sub-member 155aa. This description corresponds to the first connecting part 154a. Similarly, the same structure excluding a first protection member 155a with respect to a second protection member 155b and following description may be applied to the second connecting part 154b. Detailed description thereof will be described below.

In addition, the substrate part 150 may include a protection member 155 disposed on a side portion of the first substrate 151. In addition, the protection member 155 may include the first protection member 155a and the second protection member 155b. The first protection member 155a may be located on an outer side of the second substrate 152. The second protection member 155b may be located on an outer side of the third substrate 153. In addition, the first protection member 155a may be located on the first substrate 151. In addition, the second protection member 155b may be located on the second substrate 152. In addition, the protection member 155 may include hole members to be coupled with the second substrate 152 and the third substrate 153. For example, the first protection member 155a may include first hole members 155ah. The second protection member 155b may include second hole members 155bh. In addition, first substrate protrusions 152p may be disposed in the first hole members 155ah. In the embodiment, the first substrate protrusions 152p may pass through the first hole members 155ah. In addition, the second substrate 152 may include the first substrate protrusions 152p extending outward. The third substrate 153 may include second substrate protrusions 153p extending outward. In addition, the second substrate protrusions 153p may pass through the second hole members 155bh.

In addition, the substrate part 150 may include a heat sink 156 disposed on the first substrate 151. The heat sink 156 may be located on a lower surface of the first substrate 151. In addition, the heat sink 156 may provide heat generated from the image sensor IS of the first substrate 151 to the outside. The heat sink 156 may be formed of a metal. For example, the heat sink 156 may be formed of aluminum. For example, the heat sink 156 may be an A1 SMT part.

In addition, the substrate part 150 may include the connecting terminals 157 and 158 connected to the second substrate. For example, the connecting terminals may include a first connecting terminal 157 and a second connecting terminal 158. Any one of the first connecting terminal 157 and the second connecting terminal 158 may be a terminal through which data is transmitted and received. In addition, the other of the first connecting terminal 157 and the second connecting terminal 158 may be a terminal through which power (electrical energy) is transmitted and received.

In addition, the second substrate 152 may include a first sub-substrate and a second sub-substrate. The first sub-substrate and the second sub-substrate may be spaced apart from each other in a direction perpendicular to an optical axis on the second substrate 152. Alternatively, the first sub-substrate and the second sub-substrate may be integrally formed. However, as in the embodiment, the first sub-substrate and the second sub-substrate may be disposed apart from each other in the direction perpendicular to the optical axis (for example, in a third direction) and easily assembled and connected to the first and second connecting terminals. In addition, the first sub-substrate and the second sub-substrate may be easily stacked on the first substrate 151.

In addition, the third substrate 153 may include a third sub-substrate and a fourth sub-substrate. The third sub-substrate and the fourth sub-substrate may be spaced apart from each other in the direction perpendicular to the optical axis on the second substrate 152. Alternatively, the third sub-substrate and the fourth sub-substrate may be integrally formed. However, as in the embodiment, the third sub-substrate and the fourth sub-substrate may be disposed apart from each other in the direction perpendicular to the optical axis (for example, in the third direction) and easily assembled and connected to the first and second connecting terminals. In addition, the third sub-substrate and the fourth sub-substrate may be easily stacked on the first substrate 151.

In addition, each of the second substrate 152 and the third substrate 153 may include a hole through which a protrusion of a second body passes. Accordingly, the protrusion may pass through at least one of the second substrate 152 and the third substrate 153. In addition, the protrusion may also pass through at least a part of the first substrate. Alternatively, the protrusion may pass through the second substrate and the third substrate and may be in contact with the first substrate. In this case, the protrusion may be located adjacent to the first substrate with a pad TP interposed therebetween.

In addition, the second substrate 152 may include a hole 152h through which a protrusion 160p passes. For example, the hole 152h or substrate hole may be a hole formed by a sub-groove or sub-hole of a first sub-substrate 152a and a sub-groove or sub-hole of a second sub-substrate 152b. The first substrate 151 may be exposed through the hole. The groove or the hole 152h may overlap the first substrate 151 in the optical axis direction. In addition, the hole 152h may overlap the image sensor IS in the optical axis direction. In addition, an area of the hole 152h may be greater than an area of the image sensor IS in order to improve a heat dissipation effect. The second substrate 152 may not overlap the image sensor IS in the optical axis direction due to the groove 15e.

The protrusion 160p may pass through the hole 152h and may be located adjacent to the first substrate 151. The protrusion 160p may be in contact with the first substrate 151. As additionally described above, the heat sink 156 may be disposed on the first substrate 151. Accordingly, the protrusion 160p may be in contact with the heat sink 156. Alternatively, the pad TP may be disposed between the protrusion 160p and the heat sink 156. Accordingly, heat emitted from the image sensor IS may be transferred to the first substrate 151, the heat sink 156, the pad TP, and the protrusion 160P. Accordingly, even when the first to third substrates are formed as a stack structure, reduction of heat dissipation due to a fluid (air) present in the camera module may be easily prevented. In other words, the heat dissipation performance of the camera module may be improved. Therefore, according to the embodiment, the camera module with improved heat dissipation performance and reliability can be provided.

In addition, the image sensor IS, the first substrate 151, the heat sink 156, the pad TP, and the protrusion 160p may overlap in the optical axis direction in order to further improve heat dissipation. As described above, the pad TP may be in contact with the first substrate 151 and the protrusion 160p to effectively transfer heat from the substrate part 150 to a second body 160.

In addition, as the protrusion 160p passes through the second substrate 152 as described above, the camera module can be compact.

In addition, specifically, the substrate part 150 may include the protection member 155 disposed on a side surface of the first substrate 151, a side surface of the second substrate 152, or a side surface of the third substrate 153 as described above. The protection member 155 may correspond to a shield can. Accordingly, the protection member 155 may serve to protect elements on the substrate part 150.

In addition, the first protection member 155a of the protection member 155 according to the embodiment may include the first sub-member 155aa, the second sub-member 155ab, and a third sub-member 155ac.

The first sub-member 155aa may be located on the outer side of the second substrate 152. In addition, the first substrate protrusions 152p protruding outward from the second substrate 152 may pass through the first sub-member 155aa. In the embodiment, the first sub-member 155aa may include the first hole members 155ah. For example, the first substrate protrusions 152p of the first sub-substrate 152a and the second sub-substrate 152b may be located in the first hole members 155ah. Alternatively, the first substrate protrusions 152p of the first sub-substrate 152a and the second sub-substrate 152b may pass through the first hole members 155ah.

The second sub-member 155ab may be spaced apart from the first sub-member 155aa.

In addition, the third sub-member 155ac may be disposed between the first sub-member 155aa and the second sub-member 155ab. The third sub-member 155ac may connect the first sub-member 155aa to the second sub-member 155ab.

The second sub-member 155ab and the third sub-member 155ac may be located between the second substrate 152 and the first substrate 151. The second sub-member 155ab and the third sub-member 155ac may overlap the first substrate 151 and the second substrate 152 in the optical axis direction. Accordingly, the second sub-member 155ab and the third sub-member 155ac may support the second substrate 152 on the first substrate 151. That is, the second sub-member 155ab and the third sub-member 155ac may guide a location of the second substrate 152 on the first substrate 151.

In addition, the first sub-member 155aa or the second sub-member 155ab may be disposed on the outer side of the first substrate 151. Accordingly, the protection member 155 (first protection member) and the second substrate 152 may be coupled.

More specifically, the second substrate 152 may include the first substrate protrusions 152p extending outward as described above. The first substrate protrusions 152p may be disposed apart from the connecting part 154. According to the above-described configuration, a size of the substrate part 150 may be miniaturized.

In addition, the first sub-member 155aa may include the first hole members 155ah through which the first substrate protrusions 152p pass, and each of the first hole members may have an area which is greater than an area of each of the first substrate protrusions 152p.

That is, the first substrate protrusion 152p may have a predetermined separation distance gap1 from the first hole member 155ah. Alternatively, the first substrate protrusion 152p may be disposed to be spaced a predetermined distance from a portion of an inner surface of the first hole member 155ah. According to the above-described configuration, when the connecting terminals of the camera module and the external device are connected, damage to the substrate part may be suppressed. In addition, the camera module may be easily assembled with another device.

In addition, the second protection member 155b of the protection member 155 according to the embodiment may include a fourth sub-member 155ba, a fifth sub-member 155bb, and a sixth sub-member 155bc.

The fourth sub-member 155ba may be located on an outer side of the third substrate 153. In addition, the second substrate protrusions 153p protruding outward from the third substrate 153 may pass through the fourth sub-member 155ba. In the embodiment, the fourth sub-member 155ba may include second hole members 155bh. For example, the second substrate protrusions 153p present on the third sub-substrate and the fourth sub-substrate of the third substrate 153 may be located in the second hole member 155bh. Alternatively, the second substrate protrusions 153p of the third sub-substrate and the fourth sub-substrate may pass through the second hole members 155bh. The fifth sub-member 155bb may be spaced apart from the fourth sub-member 155ba.

In addition, the sixth sub-member 155bc may be disposed between the fourth sub-member 155ba and the fifth sub-member 155bb. The sixth sub-member 155bc may connect the fourth sub-member 155ba to the fifth sub-member 155bb.

The fifth sub-member 155bb and the sixth sub-member 155bc may be located between the third substrate 153 and the second substrate 152. The fifth sub-member 155bb and the sixth sub-member 155bc may overlap the second substrate 152 and the third substrate 153 in the optical axis direction. Accordingly, the fifth sub-member 155bb and the sixth sub-member 155bc may support the third substrate 153 on the second substrate 152. That is, the fifth sub-member 155bb and the sixth sub-member 155bc may guide a location of the third substrate 153 on the second substrate 152.

In addition, the fourth sub-member 155ba or the fifth sub-member 155bb may be disposed on the outer side of the second substrate 152. Accordingly, the protection member 155 (second protection member) and the third substrate 153 may be coupled.

More specifically, the third substrate 153 may include the second substrate protrusions 153p extending outward as described above. The second substrate protrusions 153p may be disposed apart from the connecting part 154. According to the above-described configuration, a size of the substrate part 150 may be miniaturized.

In addition, the fourth sub-member 155ba may include the second hole members 155bh through which the second substrate protrusions 153p pass, and each of the second hole members may have an area which is greater than an area of each of the second substrate protrusions 153p.

That is, the second substrate protrusion 153p may have a predetermined separation distance gap2 from the second hole member 155bh. Alternatively, the second substrate protrusion 153p may be disposed to be spaced a predetermined distance from a portion of an inner surface of the second hole member 155bh. According to the above-described configuration, when the connecting terminals of the camera module and the external device are connected, damage to the substrate part may be suppressed. In addition, the camera module may be easily assembled with another device.

The substrate part 150 may include the connecting terminals electrically connected to the first substrate, the second substrate, and the like. The connecting terminals may include the first connecting terminal 157 and the second connecting terminal 158 as described above. In addition, the connecting terminals according to the embodiment may have a structure extending in the optical axis direction.

As described above, the camera module 100 according to the third embodiment may effectively dissipate heat generated by the image sensor IS. The content of the above-described embodiment may be applied in the same manner.

In addition, the protrusion 160p of the second body 160 may pass through at least one of the second substrate 152 and the third substrate 153. As described above, the protrusion 160p may be adjacent to or in contact with the first substrate 151. Alternatively, the protrusion 160p may be in contact with the heat sink 156.

Alternatively, as a modified embodiment, a protrusion 160p may pass through at least a part of a first substrate 151. According to the above-described configuration, a distance between the protrusion 160p and an image sensor may be smaller than a thickness of the first substrate. According to the above-described configuration, heat generated from the image sensor IS may be easily dissipated to the outside through the protrusion 160p.

The protrusion 160p may be connected to the image sensor IS and overlap the image sensor IS in an optical axis direction. In addition, the protrusion 160p may pass through a second substrate 152 and a third substrate 153. In addition, the protrusion 160p may be disposed apart from the second substrate 152 and the third substrate 153. Accordingly, heat can be prevented from being applied to circuit elements mounted on the second substrate and the third substrate.

In addition, a connecting part 154 of a substrate part 150 may include a first connecting part 154a and a second connecting part 154b. The first connecting part 154a may connect the first substrate 151 to the second substrate 152. In addition, the second connecting part 154b may connect the second substrate 152 to the third substrate 153.

The first connecting part 154a and the second connecting part 154b may be disposed to face or not intersect each other on the second substrate 152. For example, the first connecting part 154a and the second connecting part 154b may be in contact with surfaces opposite to each other based on the second substrate 152. That is, the first connecting part 154a may be connected to one side of the substrate, and the second connecting part 154b may be connected to the other side of the substrate (for example, the second substrate). In addition, the first connecting part 154a and the second connecting part 154b may overlap in a direction perpendicular to an optical axis (a second direction or a Y-axis direction).

The first substrate 151, the second substrate 152, and the third substrate 153 may be disposed apart from each other in the optical axis direction.

In this case, the first protection member 155a disposed on a side portion of the first substrate 151 and the second protection member 155b disposed on a side portion of the second substrate 152 may be located close to each other.

As described above, the first protection member 155a and the second protection member 155b may be located in a region between the first connecting part 154a and the second connecting part 154b. In addition, the first protection member 155a may be disposed inside the second protection member 155b. Alternatively, the second protection member 155b may be disposed outside the first protection member 155a. That is, the second protection member 155b may be located in a region between the first protection member 155a and the third substrate 153.

In addition, a portion of the first protection member 155a may protrude from the first substrate 151 to an upper portion of the second substrate 152. In addition, a portion of the second protection member 155b may protrude from the third substrate 153 to the upper portion of the second substrate 152. In addition, the first protection member 155a may extend between the third substrate 153 and the second substrate 152.

In addition, an upper surface of the first protection member 155a may be located between third substrates 153. Alternatively, the first protection member 155a may be located between the first substrate 151 and the third substrate 153. Accordingly, the second protection member 155b and a second substrate protrusion 153p of the third substrate 153 are coupled to each other, and then the first protection member 155a and a first substrate protrusion 152p of the second substrate 152 may be coupled to each other. That is, as the first protection member 155a is disposed inside the second protection member 155b, the first substrate 151 to the third substrate 153 may be more easily assembled using the protection member.

FIG. 39 is a cross-sectional view illustrating a camera module according to a fourth embodiment.

Referring to FIG. 39, all the above-described content excluding content to be described below may be applied to the present camera module. A protrusion 160p may be in contact with a second substrate 152. That is, the protrusion 160p may pass through a third substrate 153. In addition, a pad (for example, a first pad TP1) may be located between a first substrate 151 and the second substrate 152. The first substrate 151 (or a heat sink) and the second substrate 152 may be connected to each other through the first pad TP1. Alternatively, the first pad TP1 may be in contact with the first substrate 151 and the second substrate 152.

In addition, a pad (second pad) may be located between the second substrate 152 and the protrusion 160p. Accordingly, heat emitted by an image sensor IS mounted on the first substrate 151 may be transferred to the protrusion 160p along the first substrate 151, the first pad TP1, the second substrate 152, and a second pad TP2.

Alternatively, as a modified embodiment, a protrusion 160p may pass through at least a portion of a second substrate 152. Accordingly, heat may be effectively transferred to the protrusion 160p.

In addition, as another modified embodiment, a pad may be additionally disposed between a second substrate 152 and a third substrate 153. In addition, the additionally disposed pad may be in contact with the second substrate 152 and the third substrate 153. In addition, a protrusion 160p may pass through at least a portion of the third substrate 153.

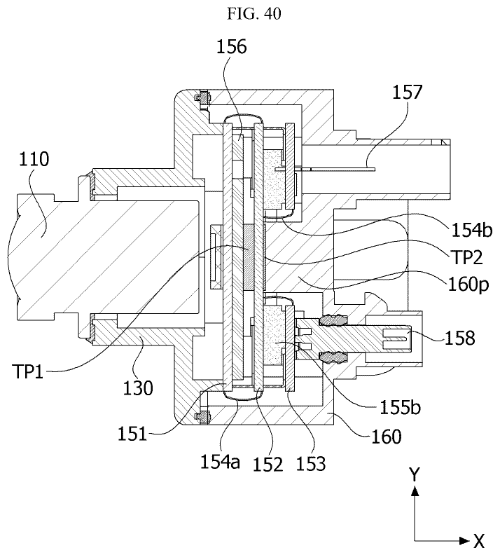

FIG. 40 is a cross-sectional view illustrating a camera module according to a fifth embodiment.

Referring to FIG. 40, all the above-described content excluding content to be described below may be applied to the present camera module. A protrusion 160p may be in contact with a second substrate 152. That is, the protrusion 160p may pass through a third substrate 153. In addition, a protrusion of the second substrate 152 may be disposed between the first substrate 151 and the second substrate 152. For example, the first substrate 151 and the second substrate 152 may be connected to each other.

In addition, a heat sink 156 may also be in contact with the first substrate 151 and the second substrate 152. In addition, a pad (a second pad) may be located between the second substrate 152 and a protrusion 160p. Accordingly, heat emitted from an image sensor IS mounted on the first substrate 151 may be transferred to the protrusion 160p along the first substrate 151, a first pad TP1, the second substrate 152, and a second pad TP2.

Alternatively, as a modified embodiment, a protrusion 160p may pass through at least a portion of a second substrate 152. Accordingly, heat may be effectively transferred to the protrusion 160p.

1. A camera module comprising:
a lens assembly;
a first body on which the lens assembly is disposed;
a second body connected to the first body;
an image sensor disposed inside the second body; and
a substrate part on which the image sensor is disposed,
wherein the second body includes a protrusion protruding toward the image sensor, and
the protrusion is connected to the image sensor and overlaps the image sensor in an optical axis direction.

2. The camera module of claim 1, wherein the protrusion passes through the substrate part.

3. The camera module of claim 1, wherein the substrate part includes:
a first substrate on which the image sensor is disposed; and
a second substrate spaced apart from the first substrate.

4. The camera module of claim 3, wherein the second substrate includes a hole through which the protrusion passes.

5. The camera module of claim 3, wherein the substrate part includes a connecting part that connects the first substrate to the second substrate.

6. The camera module of claim 3, wherein the first substrate and the second substrate are disposed apart from each other in the optical axis direction and overlap in the optical axis direction.

7. The camera module of claim 3, wherein the protrusion passes through the second substrate.

8. The camera module of claim 3, comprising a pad disposed between the protrusion and the first substrate.

9. The camera module of claim 8, wherein the pad is in contact with the first substrate and the protrusion.

10. The camera module of claim 3, wherein the substrate part includes a protection member disposed on a side portion of the first substrate.

11. The camera module of claim 10,
wherein the protection member includes a first sub-member, a second sub-member spaced apart from the first sub-member, and a third sub-member that connects the first sub-member to the second sub-member.

12. The camera module of claim 11,
wherein the third sub-member overlaps the second substrate in an optical axis direction.

13. The camera module of claim 11,
wherein the first sub-member and the second sub-member are disposed on an outer side of the first substrate.

14. The camera module of claim 11,
wherein the second substrate includes a substrate protrusion extending outward.

15. The camera module of claim 14,
wherein the first sub-member includes a hole member through which the protrusion passes.

16. The camera module of claim 15,
wherein the hole member is disposed at a predetermined separation distance from the protrusion.

17. The camera module of claim 16, comprising a first connecting terminal and a second connecting terminal that are connected to the substrate part.

18. The camera module of claim 1,
wherein the substrate part includes a first substrate on which the image sensor is disposed, a second substrate disposed apart from the first substrate, and a third substrate disposed apart from the second substrate.

19. The camera module of claim 18,
wherein the protrusion passes through at least one of the second substrate or the third substrate.

20. The camera module of claim 18,
wherein the protrusion passes through at least a part of the first substrate.
